(19) United States
(12) Patent Application Publication
(10) Pub. No.: US 2026/0107136 A1
(43) Pub. Date: Apr. 16, 2026

(54) SECURITY KEY UPDATE METHOD AND APPARATUS

(71) Applicant: BEIJING XIAOMI MOBILE SOFTWARE CO., LTD., Beijing (CN)

(72) Inventors: Yi XIONG, Beijing (CN); Yumin WU, Beijing (CN)

(21) Appl. No.: 19/116,296

(22) PCT Filed: Sep. 29, 2022
(86) PCT No.: PCT/CN2022/122941

§ 371 Date: Mar. 27, 2025

(51) Int. Cl. H04W 12/0433; H04W 12/03; H04W 12/041

(52) U.S. Cl. CPC H04W 12/0433; H04W 12/041; H04W 12/03

(57) ABSTRACT

A method for security key update, performed by a terminal or network device, includes: determining a security key corresponding to a candidate cell or cell group according to a first criterion. Determining the security key includes updating a first counter according to the first criterion, wherein the first counter is configured to determine the security key corresponding to the candidate cell or cell group and determining the security key corresponding to the candidate cell or cell group according to the first counter.

### CROSS-REFERENCE TO RELATED APPLICATION

This application is a U.S. national stage application of International Application No. PCT/CN2022/122941, filed Sep. 29, 2022, the entire contents of which are incorporated herein by reference.

### FIELD

The present disclosure relates to the field of wireless communication technology, and more particularly to methods and apparatuses for security key update.

### BACKGROUND

At present, a security key K_{SN} of an SN (secondary node) may be updated by an MN (master node), that is, the MN generates the K_{SN} of the SN and sends the K_{SN} to the SN via an Xn-C interface. In order to generate a new K_{SN}, the MN may be associated with a counter named SK-counter, so that the K_{SN} may be generated based on a security key of the MN and SK-counter. In addition, the MN may send the value of the SK-counter to a terminal through RRC (radio resource control) reconfiguration information. The security of the SN depends only on the key of the SK-counter and MN.

For subsequent CPC (conditional PSCell (primary secondary cell) change), in the existing protocol, the SK-counter stored in the CPC configuration continues to be used for generating the security key K_{SN} of the SN. For multiple subsequent CPCs on the same candidate PSCell, if the same SK-counter stored in the CPC configuration is used, the same security key K_{SN} will be generated, resulting in the reuse of the security key K_{SN}, that is, the same security key and PDCP (packet data convergence protocol) count value are used to encrypt different data packets, reducing the security of data transmission.

### SUMMARY

Embodiments of a first aspect of the present disclosure provide a method for security key update, which is performed by a terminal, and includes: determining a security key corresponding to a candidate cell or cell group according to a first criterion.

Embodiments of a second aspect of the present disclosure provide another method for security key update, which is performed by a network device, and includes: determining a security key corresponding to a candidate cell or cell group according to a first criterion.

Embodiments of a third aspect of the present disclosure provide another method for security key update, which is performed by a network device, and includes: determining a first counter, where the first counter is configured to determine a security key of a candidate cell or cell group; sending the first counter to a terminal; and determining a security key corresponding to the candidate cell or cell group according to the first counter.

Embodiments of a fourth aspect of the present disclosure provide another method for security key update, which is performed by a terminal, and includes: receiving a first counter sent by a network device, where the first counter is configured to determine a security key corresponding to a candidate cell or cell group; and determining the security key corresponding to the candidate cell or cell group according to the first counter.

Embodiments of the present disclosure provide a communication device. The communication device includes a processor and a memory having stored therein computer programs; and the processor is configured to perform the method as described in the first or fourth aspect above.

Embodiments of the present disclosure provide another communication device. The communication device includes a processor and a memory having stored therein computer programs; and the processor is configured to perform the method as described in the second or third aspect above.

### BRIEF DESCRIPTION OF THE DRAWINGS

Drawings to be used for the description of examples of the present disclosure are briefly described below.

FIG. 1 is a schematic diagram showing an EN-DC architecture;

FIG. 2 is a schematic diagram showing an NR-DC architecture;

FIG. 3 is a schematic diagram showing cell groups in a dual connectivity scenario;

FIG. 4 is a schematic architecture diagram of a communication system according to embodiments of the present disclosure;

FIG. 5 is a schematic flowchart of a method for security key update performed by a terminal according to embodiments of the present disclosure;

FIG. 6 is a schematic flowchart of another method for security key update performed by a terminal according to embodiments of the present disclosure;

FIG. 7 is a schematic flowchart of another method for security key update performed by a terminal according to embodiments of the present disclosure;

FIG. 8 is a schematic flowchart of another method for security key update performed by a terminal or network device according to embodiments of the present disclosure;

FIG. 9 is a schematic flowchart of another method for security key update performed by a terminal according to embodiments of the present disclosure;

FIG. 10 is a schematic flowchart of another method for security key update performed by a terminal according to embodiments of the present disclosure;

FIG. 11 is a schematic flowchart of another method for security key update performed by a terminal according to embodiments of the present disclosure;

FIG. 12 is a schematic flowchart of another method for security key update performed by a terminal according to embodiments of the present disclosure;

FIG. 13 is a schematic flowchart of another method for security key update performed by a terminal according to embodiments of the present disclosure;

FIG. 14 is a schematic flowchart of another method for security key update performed by a network device according to embodiments of the present disclosure;

FIG. 15 is a schematic flowchart of another method for security key update performed by a network device according to embodiments of the present disclosure;

FIG. 16 is a schematic flowchart of another method for security key update performed by a network device according to embodiments of the present disclosure;

FIG. 17 is a schematic flowchart of another method for security key update performed by a network device according to embodiments of the present disclosure;

FIG. 18 is a schematic flowchart of another method for security key update performed by a network device according to embodiments of the present disclosure;

FIG. 19 is a schematic flowchart of another method for security key update performed by a network device according to embodiments of the present disclosure;

FIG. 20 is a schematic flowchart of another method for security key update performed by a terminal according to embodiments of the present disclosure;

FIG. 21 is a schematic diagram showing interactions among various devices according to embodiments of the present disclosure;

FIG. 22 is a schematic block diagram of an apparatus for security key update according to embodiments of the present disclosure;

FIG. 23 is a schematic block diagram of a communication device according to embodiments of the present disclosure; and

FIG. 24 is a schematic block diagram of a chip according to embodiments of the present disclosure.

### DETAILED DESCRIPTION

For ease of understanding, terms used in the present disclosure are first introduced.

### 1. MR-DC (Multi-Radio Dual Connectivity)

MR-DC is a generalized Intra-E-UTRA (Intra-Evolved-Universal Mobile Telecommunications System (UMTS) Terrestrial Radio Access) Dual Connectivity. A terminal may use radio resources provided by two different schedulers, which are located on two different NG-RAN (5G radio access network) nodes and connected through a non-ideal backhaul. One of the two nodes provides NR (New Radio) access, the other node provides E-UTRA or NR access, and one node acts as an MN (Master Node), and the other node acts as SN (Secondary Node). MN and SN are connected via a network interface, and at least MN is connected to the core network.

### 2. MR-DC with EPC (Evolved Packet Core)

E-UTRAN (Evolved-UMTS Terrestrial Radio Access Network) supports MR-DC through E-UTRA-NR DC (Evolved-UMTS Terrestrial Radio Access-New Radio Dual Connectivity, referred to as EN-DC for short). A terminal is connected to an eNB (evolved NodeB, a 4G base station) acting as an MN and an en-gNB (en-next generation NodeB, a modified 5G base station) acting as an SN.

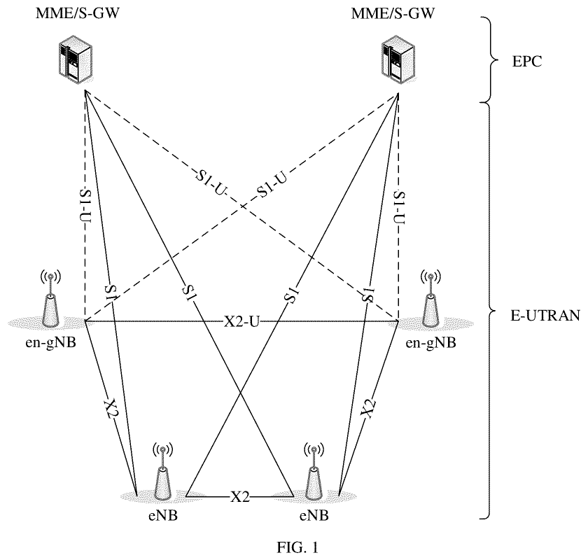

As an example, an architecture diagram of the EN-DC may be as shown in FIG. 1, where an eNB is connected to an EPC via an S1 interface, an eNB is connected to an en-gNB via an X2 interface; an en-gNB is connected to an EPC via an S1-U interface, and an en-gNB is connected to another en-gNB via an X2-U interface. The MME in FIG. 1 is the abbreviation of Mobility Management Entity, and S-GW is the abbreviation of Serving Gate Way.

### 3. MR-DC with 5GC (5G Core)

### (1) E-UTRA-NR Dual Connectivity NGEN-DC (NG-RAN E-UTRA-NR Dual Connectivity, 5G Radio Access Network Evolved UMTS Terrestrial Radio Access-New Radio Dual Connectivity)

NG-RAN supports NGEN-DC, where a terminal is connected to an ng-eNB (next generation evolved NodeB) acting as an MN and a gNB (next generation NodeB) acting as an SN. The ng-eNB is connected to the 5GC, and the gNB is connected to the ng-eNB via an Xn interface.

### (2) NR-E-UTRA Dual Connectivity (NE-DC for Short)

NG-RAN supports NE-DC, where a terminal is connected to a gNB acting as an MN and an ng-eNB acting as an SN. The gNB is connected to the 5GC, and the ng-eNB is connected to the gNB via an Xn interface.

### (3) NR-NR Dual Connectivity (NR-DC for Short)

NG-RAN supports NR-DC, where a terminal is connected to a gNB acting as an MN and a gNB acting as an SN. The primary gNB is connected to the 5GC via an NG interface, the secondary gNB is connected to the 5GC via an NG-U interface, and the gNBs are connected to each other via an Xn interface. In addition, NR-DC may also be used for a terminal to access a single gNB, and in this case, the gNB accessed by the terminal may act as both the MN and the SN, and both MCG and SCG are configured.

As an example, an architecture of the NR-DC may be as shown in FIG. 2.

### 4. PCell (Primary Cell), SCell (Secondary Cell) and PSCell (Primary Secondary Cell)

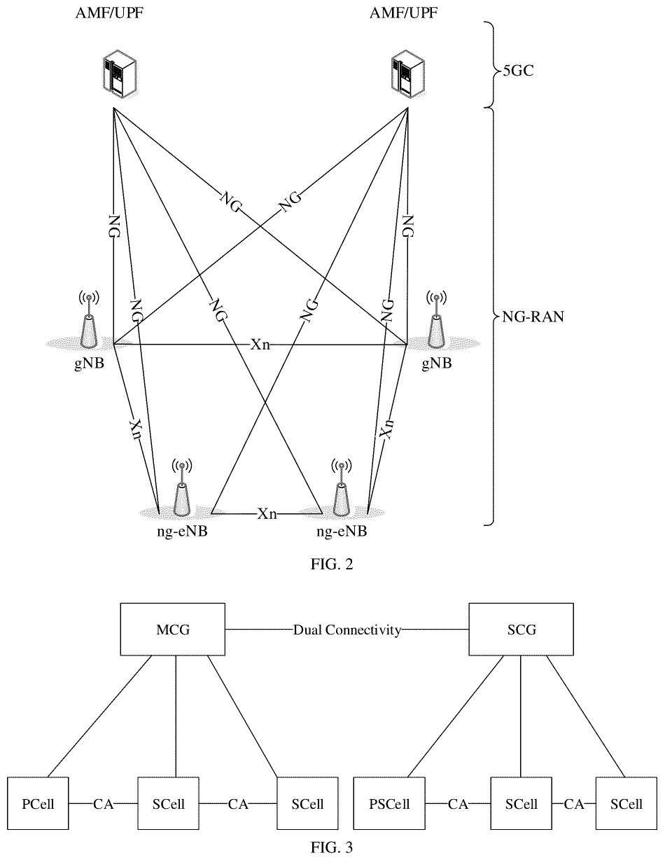

In a Dual Connectivity scenario, a terminal may access two cell groups, namely MCG (Master Cell group) and SCG (Secondary Cell group), where MCG and SCG correspond to MN and SN at the network device side, respectively. MCG may include multiple cells, among which the cell used for initiating initial access is called PCell, which, as the name implies, is the most “primary” cell in MCG. As shown in FIG. 3, in addition to PCell, MCG may also include SCell, where PCell and SCell are jointed together through CA (Carrier Aggregation). SCG may include PSCell (Primary Secondary Cell) and SCell. Since many signalings are only sent on PCell and PSCell, for the convenience of description, the protocol also defines a concept: SpCell (special Cell), as shown in FIG. 3, PCell and PSCell may be collectively referred to as SpCells.

That is, MCG includes SpCell (PCell) and one or more SCells. MCG refers to a group of serving cells associated with MN in MR-DC. MN refers to a radio access node that provides a connection to a control plane of a core network in MR-DC. MN may be a master eNB (in EN-DC), a master ng-eNB (in NGEN-DC) or a master gNB (in NR-DC and NE-DC).

SCG includes SpCell (PSCell) and one or more SCells. SCG refers to a group of serving cells associated with SN in MR-DC. SN refers to a radio access node in MR-DC, which may not provide a connection to a control plane of a core network, and provides additional resources for a terminal. SN may be an en-gNB (in EN-DC), a secondary ng-eNB (in NE-DC) or a secondary gNB (in NR-DC and NGEN-DC).

### 5. Selective Activation of Cell Groups

For CHO (Conditional Handover) in Rel-16 and CPC (Conditional PSCell Change) or CPA (Conditional PSCell Addition) in Rel-17, a terminal with CHO/CPC/CPA configuration needs to release the CHO/CPC/CPA configuration when completing random access to a target PCell/PSCell. If the network device does not reconfigure and reinitialize CHO/CPC/CPA, the terminal cannot continue to perform CHO/CPC/CPA, which will increase the delay of handover or SCG change, and increase signaling overhead, especially in the scenario of frequently changing CG (Cell group) in the FR2 high frequency band.

Therefore, in the establishment of the mobility enhancement project, selective activation of cell groups in MR-DC is proposed. The selective activation of cell groups enables the CHO/CPC/CPA still available subsequently after the CG change, without the network device to reconfigure or reinitialize the CHO/CPC/CPA, thereby reducing signaling overhead and reducing the interruption duration due to the CG change.

In the selective activation of cell groups, the network device may provide the terminal with “cell groups to be activated”, so that the “cell groups to be activated” may be activated or deactivated subsequently, without the network device to re-provide the configuration of the cell groups.

Cell group selective activation configuration information may include at least one of: a configuration ID, an activation condition (possible), or configuration of cell groups/cells to be activated.

The selective activation of cell groups enables the subsequent configuration still executable after the cell group change, without the need for the network to reconfigure or reinitialize the corresponding configuration for the selective activation of cell groups. Therefore, in the selective activation of cell groups, the network device may provide the terminal with “cell groups to be activated”. The “cell group to be activated” may be activated or deactivated subsequently, without re-providing the configuration of cell groups.

In the selective activation of cell groups, the network device may provide the terminal with a preconfigured candidate target cell group or target cell. The terminal may subsequently activate or deactivate the preconfigured candidate cell group or cell according to a configuration (e.g., an activation message) sent by the network device or a corresponding activation event, without the configuration of the cell group to be re-provided. Alternatively, it may also be understood that in the selective activation of cell groups, after activating a new cell or cell group, or after applying a new cell configuration or cell group configuration, or after accessing a new cell or cell group, the terminal will not delete the corresponding configuration information for the selective activation of cell groups.

The selective activation of cell groups may also be called cell group activation. The cell group activation makes the corresponding configuration information still available after the cell group or cell change, without the need for the network to reconfigure or reinitialize the corresponding configuration information for the cell group activation. Therefore, the cell group activation may reduce signaling overhead and reduce the interruption duration due to the cell group change. The configuration information for the cell group activation may include: a configuration ID, and a configuration of the target cell or a configuration of the target cell group. Optionally, the configuration information for the cell group activation may also include a trigger condition (also referred to as an execution condition or an activation condition).

In an embodiment, the cell group activation is a mobility management process, including any mobility management process in which a cell group activation configuration is configured, and a terminal activates or deactivates a corresponding cell or cell group, applies a corresponding cell configuration or cell group configuration, or accesses a cell or cell group according to a signaling sent by the network or a criterion specified in the protocol; or the terminal autonomously activates or deactivates a corresponding cell or cell group, applies a corresponding cell configuration or cell group configuration, or accesses a cell or cell group.

In an embodiment, the cell group activation is a mobility management process, including any mobility management process in which a part or all of the corresponding configuration information is not deleted or released after performing the mobility process. Not deleting or releasing a part or all of the corresponding configuration information may also be called retaining a part or all of the corresponding configuration information.

In the present disclosure, cell groups include one or more of the primary cell group (MCG) and the secondary cell group (SCG). The MCG includes one or more of the primary cell (PCell) and the secondary cell (SCell). The SCG includes one or more of the primary secondary cell (PSCell) and the secondary cell (SCell).

In the present disclosure, the selective activation of cell groups may include one or more of cell selective activation or cell activation, for example, PCell activation, PSCell activation, or SCell activation.

It should be noted that when performing the selective activation of cell groups, it is necessary to determine whether there is a security issue: e.g. to determine vertical or horizontal key derivation, e.g. security parameters re-used as part of subsequent CG switch (for the case when UE goes back to a previous cell, maybe in another SN), and FFS (for further study) on the procedure/method with which the UE derives the SN security, e.g. based on a prior MN configuration (without RRC CPC configuration at the time of SN switch).

### 6. SK-Counter

The SK-counter is a counter used upon initial configuration of SN security for NR-DC and NE-DC, as well as upon refresh of S-K_{gNB} or S-K_{gNB} based on the current or newly derived K_{gNB} during RRC resume or RRC reconfiguration, as defined in TS 33.501 [11].

### 7. SN Counter Maintenance

The MN shall maintain a 16-bit counter, SN counter, in its AS (access stratum) security context. The SN counter is used when computing the K_{SN}.

The MN maintains the value of the SN counter for a duration of the current 5G AS security context between UE and MN. The UE does not need to maintain the value of the SN counter after it has computed the K_{SN} since the MN provides the UE with the current SN counter value when the UE needs to compute a new K_{SN}.

The SN counter is a fresh input to K_{SN} derivation. That is, the UE assumes that the MN provides a fresh SN counter each time and does not need to verify the freshness of the SN counter.

Note: An attacker cannot, over the air modify the SN counter and force re-use of the same SN counter. The reason for this is that the SN counter is delivered over the RRC connection between the MN and the UE, and this connection is both integrity protected and protected from replay.

The MN shall set the SN counter to “0” when a new AS root key, K_{NG-RAN}, in the associated 5G AS security context is established. The MN shall set the SN counter to “1” after the first calculated K_{SN}, and monotonically increment it for each additional calculated K_{SN}. The SN counter value “0” is used to calculate the first K_{SN}.

If the MN decides to release the offloaded connections to the SN and later decides to re-start the offloading to the same SN, the SN counter value shall keep increasing, thus keeping the computed K_{SN} fresh.

The MN shall refresh the root key of the 5G AS security context associated with the SN counter before the SN counter wraps around. Refreshing the root key is done using intra cell handover. When the root key is refreshed, the SN counter is reset to “0” as defined above.

### 8. Derivation of Keys

The UE and MN shall derive the security key K_{SN} of the SN. The SN RRC and UP (User Plane) keys shall be derived from the K_{SN} both at the SN and the UE using the function given in Annex A.7 of TS 33.401[10] if the SN is a ng-eNB. Once all the SN RRC and UP keys have been derived from the K_{SN}, the SN and UE may delete the K_{SN}.

### 7. Derivation of K_{SN} for Dual Connectivity

When the MN and UE derive K_{SN} during dual connectivity, the following input parameters may be used:
FC=0x79,
P0=value of the SN counter as a non-negative integer,
L0=length of the SN counter value (such as 0x00, 0x02).

The input key KEY shall be K_{eNB} when the MN is an ng-eNB, and the input key KEY shall be K_{gNB} when the MN is a gNB.

In order to better understand a method for security key update disclosed in embodiments of the present disclosure, the communication system to which the embodiments of the present disclosure are applicable is first described below.

In order to make the objectives, technical solutions and advantages of the present disclosure clearer, embodiments of the present disclosure will be further described in detail below with reference to the accompanying drawings.

Reference will now be made in detail to illustrative embodiments, examples of which are illustrated in the accompanying drawings. The following description refers to the accompanying drawings in which the same numbers in different drawings represent the same or similar elements unless otherwise represented. The implementations described in the following illustrative embodiments do not represent all implementations consistent with the present disclosure. Instead, they are merely examples of apparatuses and methods consistent with some aspects of the present disclosure as recited in the appended claims.

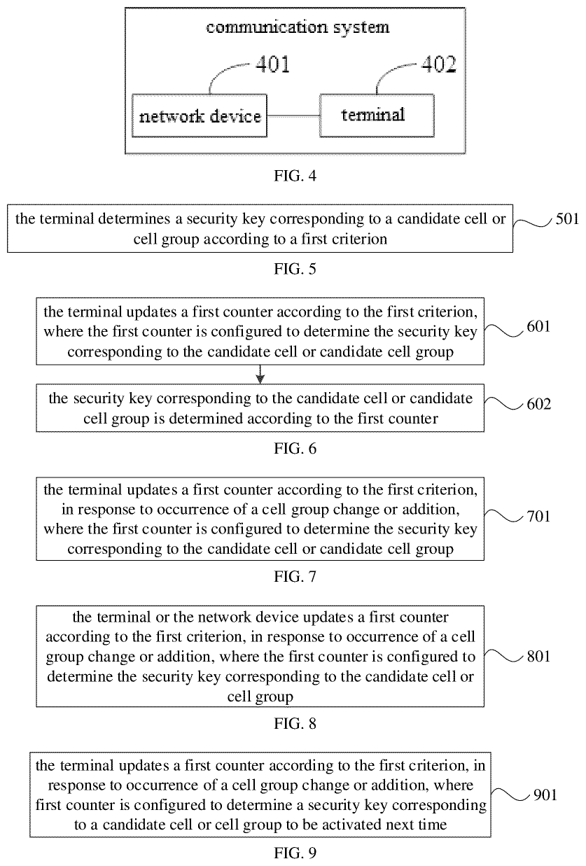

Referring to FIG. 4, FIG. 4 is a schematic architecture diagram of a communication system according to embodiments of the present disclosure. The communication system may include, but not limited to, a network device and a terminal. The number and forms of the devices shown in FIG. 4 are used as an example and do not constitute a limitation on embodiments of the present disclosure. The communication system may include two or more network devices and two or more terminals in practical applications. As an example for illustration, the communication system shown in FIG. 4 includes one network device 401 and one terminal 402.

It should be noted that the technical solutions of embodiments of the present disclosure may be applied to various communication systems, for example, a long term evolution (LTE) system, a 5th generation (5G) mobile communication system, a 5G new radio (NR) system, or other new mobile communication systems in the future.

The network device 401 in embodiments of the present disclosure is an entitty at a network side for sending or receiving signals. For example, the network device 401 may be an evolved NodeB (eNB), a transmission reception point (TRP, also called transmit receive point), a next generation NodeB (gNB) in an NR system, a base station in other future mobile communication systems, or an access node in a wireless fidelity (WiFi) system. Embodiments of the present disclosure do not limit the specific technique and specific device form adopted by the network device. The network device according to embodiments of the present disclosure may be composed of a central unit (CU) and distributed units (DUs). The CU may also be called a control unit. The CU-DU structure allows to split protocol layers of the network device, such as a base station, functions of some protocol layers are centrally controlled in the CU, functions of some or all of the remaining protocol layers are distributed in the DUs, and the CU centrally controls the DUs.

The terminal 402 in embodiments of the present disclosure is an entity at a user side for receiving or sending signals, such as a mobile phone. The terminal may also be called a terminal, a user equipment (UE), a mobile station (MS), a mobile terminal (MT), and so on. The terminal may be a device with a communication function, such as a car, a smart car, a mobile phone, a wearable device, a tablet Pad, a computer with a wireless transceiver function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. Embodiments of the present disclosure do not limit the specific technique and the specific device form adopted by the terminal.

In the above communication system, an MN generates K_{SN} of an SN and sends the K_{SN} to the SN via an Xn-C interface. In order to generate a new K_{SN}, the MN may be associated with a counter named SK-counter, so that the K_{SN} may be generated based on a security key of the MN and SK-counter. In addition, the MN may send the value of the SK-counter to a terminal through RRC reconfiguration information. The security of the SN depends only on the key of the SK-counter and MN.

For subsequent CPC, in the existing protocol, the SK-counter stored in the CPC configuration continues to be used for generating the K_{SN}. For multiple subsequent CPCs on the same candidate PSCell, if the same SK-counter stored in the CPC configuration is used, the same security key K_{SN} will be generated, resulting in the reuse of the security key K_{SN}, that is, the same security key and PDCP count value are used to encrypt different data packets, reducing the security of data transmission.

In view of the above problems, the present disclosure provides a method and apparatus for security key update.

It may be understood that the communication system described in embodiments of the present disclosure is for the purpose of more clearly illustrating the technical solutions of the embodiments of the present disclosure, and does not constitute a limitation on the technical solutions according to the embodiments of the present disclosure. It will be appreciated to those ordinarily skilled in the art that with the evolution of the system architecture and the emergence of new service scenarios, the technical solutions according to embodiments of the present disclosure are also applicable to similar technical problems.

Embodiments of a first aspect of the present disclosure provide a method for security key update, which is performed by a terminal, and includes: determining a security key corresponding to a candidate cell or cell group according to a first criterion.

In this technical solution, the terminal determines the security key corresponding to the candidate cell or cell group according to the first criterion. Therefore, the security key corresponding to the candidate cell or candidate cell group may be updated to avoid the repeated use of the security key, that is, to avoid using the repeated security key to encrypt different data packets, so as to improve the security of data transmission.

Embodiments of a second aspect of the present disclosure provide another method for security key update, which is performed by a network device, and includes: determining a security key corresponding to a candidate cell or cell group according to a first criterion.

Embodiments of a third aspect of the present disclosure provide another method for security key update, which is performed by a network device, and includes: determining a first counter, where the first counter is configured to determine a security key of a candidate cell or cell group; sending the first counter to a terminal; and determining a security key corresponding to the candidate cell or cell group according to the first counter.

Embodiments of a fourth aspect of the present disclosure provide another method for security key update, which is performed by a terminal, and includes: receiving a first counter sent by a network device, where the first counter is configured to determine a security key corresponding to a candidate cell or cell group; and determining the security key corresponding to the candidate cell or cell group according to the first counter.

Embodiments of a fifth aspect of the present disclosure provide an apparatus for security key update, which has some or all of functions for implementing the method as described in the first or fourth aspect above. For example, the apparatus for security key update may have functions as described in some or all the embodiments in the present disclosure, or may also have functions to separately implement any of embodiments in the present disclosure. The functions may be implemented by hardware, or may be implemented by software executed on corresponding hardware. The hardware or the software includes one or more units or modules corresponding to the above functions.

In an embodiment, the apparatus for security key update may include a transceiver module and a processing module in structure. The processing module is configured to support the apparatus for security key update to perform corresponding functions in the above method. The transceiver module is configured to support the apparatus for security key update to communicate with other devices. The apparatus for security key update may further include a storage module, which is configured to couple with the transceiver module and the processing module, and store computer programs and data necessary for the apparatus for security key update.

As an example, the processing module may be a processor, the transceiver module may be a transceiver or a communication interface, and the storage module may be a memory.

Embodiments of a sixth aspect of the present disclosure provide another apparatus for security key update, which has some or all of functions for implementing the method embodiments as described in the second or third aspect above. For example, the apparatus for security key update may have functions as described in some or all the embodiments in the present disclosure, or may also have functions to separately implement any of embodiments in the present disclosure. The functions may be implemented by hardware, or may be implemented by software executed on corresponding hardware. The hardware or the software includes one or more units or modules corresponding to the above functions.

In an embodiment, the apparatus for security key update may include a transceiver module and a processing module in structure. The processing module is configured to support the apparatus for security key update to perform corresponding functions in the above method. The transceiver module is configured to support the apparatus for security key update to communicate with other devices. The apparatus for security key update may further include a storage module, which is configured to couple with the transceiver module and the processing module, and store computer programs and data necessary for the apparatus for security key update.

Embodiments of a seventh aspect of the present disclosure provide a communication device. The communication device includes a processor, and the processor is configured to perform the method as described in the first or fourth aspect when calling computer programs in a memory.

Embodiments of an eighth aspect of the present disclosure provide another communication device. The communication device includes a processor, and the processor is configured to perform the method as described in the second or third aspect when calling computer programs in a memory.

Embodiments of a ninth aspect of the present disclosure provide a communication device. The communication device includes a processor and a memory having stored therein computer programs; and the processor is configured to execute the computer programs stored in the memory to cause the communication device to perform the method as described in the first or fourth aspect above.

Embodiments of a tenth aspect of the present disclosure provide another communication device. The communication device includes a processor and a memory having stored therein computer programs; and the processor is configured to execute the computer programs stored in the memory to cause the communication device to perform the method as described in the second or third aspect above.

Embodiments of an eleventh aspect of the present application provide another communication device. The device includes a processor and an interface circuit. The interface circuit is configured to receive code instructions and transmit the code instructions to the processor. The processor is configured to run the code instructions to cause the device to perform the method as described in the first or fourth aspect above.

Embodiments of a twelfth aspect of the present application provide another communication device. The device includes a processor and an interface circuit. The interface circuit is configured to receive code instructions and transmit the code instructions to the processor. The processor is configured to run the code instructions to cause the device to perform the method as described in the second or third aspect above.

Embodiments of a thirteenth aspect of the present disclosure provide a communication system, and the system includes the apparatus for security key update as described in the fifth aspect and the apparatus for security key update as described in the sixth aspect, or the system includes the communication device as described in the seventh aspect and the communication device as described in the eighth aspect, or the system includes the communication device as described in the ninth aspect and the communication device as described in the tenth aspect, or the system includes the communication device as described in the eleventh aspect and the communication device as described in the twelfth aspect.

Embodiments of a fourteenth aspect of the present disclosure provide a non-transitory computer-readable storage medium for storing instructions to be used by the above communication device, and the instructions, when executed, cause the communication device to perform the method as described in the first or fourth aspect above.

Embodiments of a fifteenth aspect of the present disclosure provide another non-transitory computer-readable storage medium for storing instructions to be used by the above communication device, and the instructions, when executed, cause the communication device to perform the method as described in the second or third aspect above.

Embodiments of a sixteenth aspect of the present disclosure further provide a computer program product, which includes computer programs that, when run on a computer, cause the computer to perform the method as described in the first or fourth aspect above.

Embodiments of a seventeenth aspect of the present disclosure further provide another computer program product, which includes computer programs that, when run on a computer, cause the computer to perform the method as described in the second or third aspect above.

Embodiments of an eighteenth aspect of the present disclosure provide a chip system, which includes at least one processor and at least one interface, for supporting the communication device to implement functions described in the first or fourth aspect, for example, to determine or process at least one of data and information involved in the above method. In a possible design, the chip system further includes a memory for storing computer programs and data necessary for the communication device. The chip system may consist of chips, or may include chips and other discrete devices.

Embodiments of a nineteenth aspect of the present disclosure provide another chip system, which includes at least one processor and at least one interface, for supporting the communication device to implement functions described in the second or third aspect, for example, to determine or process at least one of data and information involved in the above method. In a possible design, the chip system further includes a memory for storing computer programs and data necessary for the communication device. The chip system may consist of chips, or may include chips and other discrete devices.

Embodiments of a twentieth aspect of the present disclosure provide a computer program that, when run on a computer, causes the computer to perform the method as described in the first or fourth aspect above.

Embodiments of a twenty-first aspect of the present disclosure provide another computer program that, when run on a computer, causes the computer to perform the method as described in the second or third aspect above.

The method and apparatus for security key update provided in the present disclosure are described in detail below with reference to the accompanying drawings.

Referring to FIG. 5, FIG. 5 is a schematic flowchart of a method for security key update according to embodiments of the present disclosure. The method for security key update may be performed by a terminal as shown in FIG. 4.

The method for security key update may be performed alone, or in combination with any embodiment of the present disclosure or a possible implementation of an embodiment, or in combination with any technical solution in the related art.

As shown in FIG. 5, the method for security key update may include but is not limited to a following step.

In step 501, a security key corresponding to a candidate cell or candidate cell group is determined according to a first criterion.

In embodiments of the present disclosure, the first criterion may be specified by a protocol.

In embodiments of the present disclosure, the candidate cell group may be for example a candidate SCG, and the candidate cell may be for example a candidate PSCell.

In embodiments of the present disclosure, the terminal may determine the security key corresponding to the candidate cell or candidate cell group according to the first criterion specified by the protocol.

For example, the security key corresponding to the candidate cell or candidate cell group refers to a security key of a node where the candidate cell or candidate cell group is located.

As an example, the candidate cell group may be an SCG, and the security key corresponding to the candidate cell group may be a security key corresponding to a candidate SN or a candidate PSCell corresponding to the candidate SCG. For example, the security key of the candidate cell group may be K_{SN} (a security key of a candidate SN) or S-K_{gNB} (a security key of a 5G node) or S-K_{eNB} (a security key of a 4G node).

As a possible implementation, the network device may also determine the security key corresponding to the candidate cell or candidate cell group according to the first criterion. That is, the network device may update the security key corresponding to the candidate cell or candidate cell group according to the first criterion.

The security key updated by the terminal according to the first criterion is the same as the security key updated by the network device according to the first criterion.

With the method for security key update according to embodiments of the present disclosure, the security key corresponding to the candidate cell or candidate cell group is determined by the terminal according to the first criterion. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 6, FIG. 6 is a schematic flowchart of another method for security key update according to embodiments of the present disclosure. The method for security key update may be performed by a terminal as shown in FIG. 4.

The method for security key update may be performed alone, or in combination with any embodiment of the present disclosure or a possible implementation of an embodiment, or in combination with any technical solution in the related art.

As shown in FIG. 6, the method for security key update may include but is not limited to the following steps.

In step 601, a first counter is updated according to a first criterion, and the first counter is configured to determine a security key corresponding to a candidate cell or candidate cell group.

It should be noted that, for the explanation and illustration of the first criterion, the candidate cell and the candidate cell group, reference may be made to the relevant description in any embodiment of the present disclosure, which will not be repeated here.

For example, updating the first counter is updating a value of the first counter.

In embodiments of the present disclosure, the first counter may be a counter corresponding to the candidate cell or candidate cell group, and the first counter may be, for example, an SK-counter.

For example, the security key corresponding to the candidate cell or candidate cell group refers to a security key of a node where the candidate cell or candidate cell group is located.

As an example, the first counter may be a common or universal counter for candidate cells or candidate cell groups, for example, the first counter may be a common or universal SK-counter, and the common or universal counter is applicable to any candidate cell or any candidate cell group; or the first counter may be a counter specific to a candidate cell or candidate cell group, for example, the first counter may be a specific SK-counter, i.e., each candidate cell or candidate cell group corresponds to an SK-counter.

In embodiments of the present disclosure, the terminal may update the value of the first counter according to the first criterion, and the value of the first counter is used to determine the security key of the candidate cell, or the value of the first counter is used to determine the security key of the candidate cell group, for example, the value of the first counter is used to generate or derive the security key of the candidate cell or candidate cell group.

As an example, the terminal may update the value of the first counter according to the first criterion to obtain an updated value of the first counter.

An initial value of the first counter may be configured by the network device for the terminal. The network device may be, for example, an MN currently serving the terminal.

For example, the initial value of the first counter may also be specified by a protocol.

As a possible implementation, the network device may also update the value of the first counter according to the first criterion to obtain the updated value of the first counter, and determine the security key corresponding to the candidate cell or candidate cell group according to the updated value of the first counter.

For example, if the initial value of the first counter is the same for the terminal and the network device, and the terminal and the network device update the value of the first counter according to the same first criterion, then the value of the first counter updated by the terminal is also the same as the value of the first counter updated by the network device. In this way, the terminal and the network device may subsequently make calculation based on the updated value of the first counter to obtain the same security key, thereby realizing the update of the security key corresponding to the candidate cell or candidate cell group.

In step 602, the security key corresponding to the candidate cell or candidate cell group is determined according to the first counter.

In embodiments of the present disclosure, the terminal may determine the security key of the candidate cell group or the security key of the candidate cell according to the updated value of the first counter.

With the method for security key update according to embodiments of the present disclosure, the terminal updates the first counter according to the first criterion, the first counter is used to determine the security key corresponding to the candidate cell or candidate cell group, and the security key corresponding to the candidate cell or candidate cell group is determined according to the updated first counter. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 7, FIG. 7 is a schematic flowchart of another method for security key update according to embodiments of the present disclosure. The method for security key update may be performed by a terminal as shown in FIG. 4.

The method for security key update may be performed alone, or in combination with any embodiment of the present disclosure or a possible implementation of an embodiment, or in combination with any technical solution in the related art.

As shown in FIG. 7, the method for security key update may include but is not limited to a following step.

In step 701, in response to occurrence of a cell group change or addition, a first counter is updated according to a first criterion, and the first counter is configured to determine a security key corresponding to a candidate cell or candidate cell group.

For example, the security key corresponding to the candidate cell or candidate cell group refers to a security key of a node where the candidate cell or cell group is located.

For example, updating the first counter is updating a value of the first counter.

It should be noted that, for the explanation and illustration of the first criterion, the first counter, the candidate cell and the candidate cell group, reference may be made to the relevant description in any embodiment of the present disclosure, which will not be repeated here.

In embodiments of the present disclosure, when a cell group change occurs (for example, an SCG change) or when a cell group addition occurs (for example, an SCG addition), the terminal may update the value of the first counter according to the first criterion, and the value of the first counter is used to determine the security key corresponding to the candidate cell or candidate cell group.

As an example, in response to the occurrence of the cell group change or addition, the terminal may add a first numerical value to the current value of the first counter according to the first criterion to obtain an updated value of the first counter.

The first numerical value may be specified by a protocol, or may be pre-configured by a network device, and the present disclosure does not impose any limitation thereon.

A first case: the terminal triggers the cell group change or addition. For example, the terminal triggers the cell group change or addition when meeting a trigger condition for CPAC (conditional PSCell addition or change).

A second case: the terminal sends a reconfiguration completion message to the network device.

The network device may be an MN currently serving the terminal.

A third case: the terminal initiates a random access. For example, the terminal initiates RACH (random access channel).

A fourth case: the terminal successfully accesses a changed target cell, or the terminal successfully accesses an added target cell, or the terminal successfully accesses a changed target cell group, or the terminal successfully accesses an added target cell group.

With the method for security key update according to embodiments of the present disclosure, the terminal updates the first counter according to the first criterion in response to the occurrence of the cell group change or addition, the first counter is used to determine the security key corresponding to the candidate cell or cell group. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 8, FIG. 8 is a schematic flowchart of another method for security key update according to embodiments of the present disclosure. The method for security key update may be performed by a terminal or a network device as shown in FIG. 4.

The network device may be an MN serving the terminal.

The method for security key update may be performed alone, or in combination with any embodiment of the present disclosure or a possible implementation of an embodiment, or in combination with any technical solution in the related art.

As shown in FIG. 8, the method for security key update may include but is not limited to a following step.

In step 801, in response to occurrence of a cell group change or addition, the terminal or the network device updates a first counter according to a first criterion, and the first counter is configured to determine a security key corresponding to a candidate cell or candidate cell group.

It should be noted that, for the explanation and illustration of the first criterion, the first counter, the candidate cell, the candidate cell group, and the occurrence of the cell group change or addition, reference may be made to the relevant description in any embodiment of the present disclosure, which will not be repeated here.

For example, the security key corresponding to the candidate cell or candidate cell group refers to a security key of a node where the candidate cell or candidate cell group is located.

For example, updating the first counter is updating a value of the first counter.

In embodiments of the present disclosure, when a cell group change occurs (for example, an SCG change) or when a cell group addition occurs (for example, an SCG addition), the terminal or the network device may update the value of the first counter corresponding to the candidate cell or candidate cell group according to the first criterion, and the value of the first counter is used to determine the security key corresponding to the candidate cell or cell group.

It should be noted that the terminal and the network device may update the value of the first counter synchronously, or the terminal and the network device may update the value of the first counter asynchronously, and the present disclosure does not impose any limitation thereon.

As an example, in response to the occurrence of the cell group change or addition, the terminal or the network device may add a first numerical value to the current value of the first counter according to the first criterion to obtain an updated value of the first counter.

The first numerical value may be specified by a protocol, or may be pre-configured by the network device, and the present disclosure does not impose any limitation thereon.

In a possible implementation of an embodiment of the present disclosure, for the network device side, the occurrence of the cell group change or addition may include one or more of:
1) receiving a reconfiguration completion message sent by the terminal;
2) the terminal successfully accessing a changed or added target cell or target cell group; or
3) the network device as an MN receiving a security key update request message sent by an SN.

For example, the network device updates the value of the first counter, and makes calculation based on the updated value of the first counter to obtain the security key, which may be used for subsequent activation of the candidate cell or candidate cell group.

With the method for security key update according to embodiments of the present disclosure, the terminal or the network device updates the first counter according to the first criterion in response to the occurrence of the cell group change or addition, and the first counter is used to determine the security key corresponding to the candidate cell or cell group. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 9, FIG. 9 is a schematic flowchart of another method for security key update according to embodiments of the present disclosure. The method for security key update may be performed by a terminal as shown in FIG. 4.

The method for security key update may be performed alone, or in combination with any embodiment of the present disclosure or a possible implementation of an embodiment, or in combination with any technical solution in the related art.

As shown in FIG. 9, the method for security key update may include but is not limited to a following step.

In step 901, in response to occurrence of a cell group change or addition, a first counter is updated according to a first criterion, and the first counter is configured to determine a security key corresponding to a candidate cell or candidate cell group to be activated next time.

It should be noted that, for the explanation and illustration of the first criterion, the first counter, the candidate cell, the candidate cell group, and the occurrence of the cell group change or addition, reference may be made to the relevant description in any embodiment of the present disclosure, which will not be repeated here.

For example, the security key corresponding to the candidate cell or candidate cell group refers to a security key of a node where the candidate cell or candidate cell group is located.

For example, updating the first counter is updating a value of the first counter.

In embodiments of the present disclosure, when the cell group change or addition occurs, the terminal may update the value of the first counter according to the first criterion, and the updated value of the first counter is used to determine the security key corresponding to the candidate cell or candidate cell group to be activated next time.

As an example, when a trigger condition for CPAC is met, for example when a candidate cell or candidate cell group is about to be deactivated, the terminal may update the value of the first counter according to the first criterion, so that the security key corresponding to the candidate cell or candidate cell group to be activated next time may be determined according to the updated value of the first counter.

For example, after meeting the trigger condition for CPAC, and before initiating RACH and/or reconfiguration completion message, the terminal may update the value of the first counter according to the first criterion, and generate the security key corresponding to the candidate cell or candidate cell group according to the updated value of the first counter.

As another example, before or after the activation of a cell group currently activated is completed, the terminal may update the value of the first counter according to the first criterion, so that the terminal may determine the security key corresponding to the candidate cell or candidate cell group to be activated next time according to the updated value of the first counter, and wait for the activation of a subsequent candidate cell or candidate cell group.

In a possible implementation of an embodiment of the present disclosure, the first counter may be a common or universal counter, and the common or universal counter is applicable to any candidate cell or any candidate cell group.

With the method for security key update according to embodiments of the present disclosure, the terminal updates the first counter according to the first criterion in response to the occurrence of the cell group change or addition, and the first counter is used to determine the security key corresponding to the candidate cell or candidate cell group to be activated next time. Therefore, the security key corresponding to the candidate cell or candidate cell group may be updated to avoid the repeated use of the security key, that is, to avoid using the repeated security key to encrypt different data packets, so as to improve the security of data transmission.

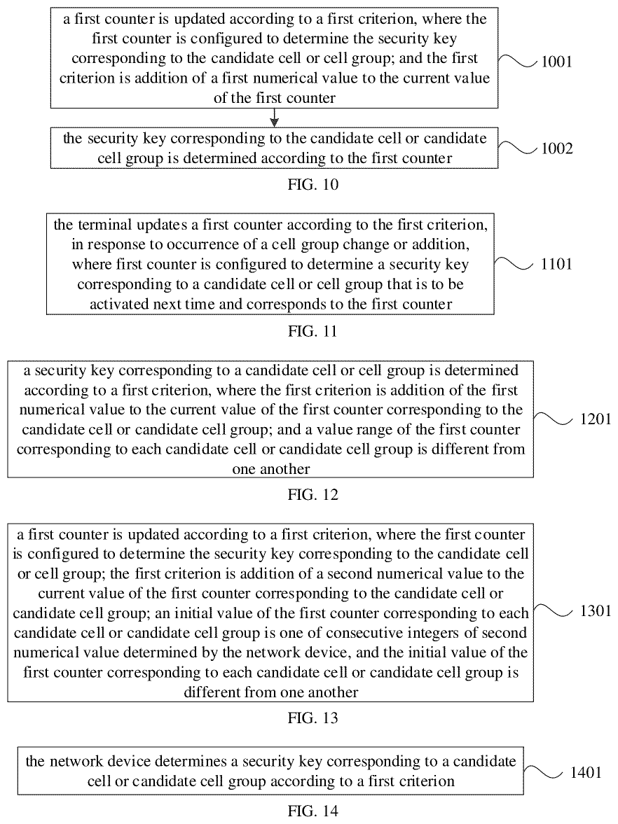

Referring to FIG. 10, FIG. 10 is a schematic flowchart of another method for security key update according to embodiments of the present disclosure. The method for security key update may be performed by a terminal as shown in FIG. 4.

The method for security key update may be performed alone, or in combination with any embodiment of the present disclosure or a possible implementation of an embodiment, or in combination with any technical solution in the related art.

As shown in FIG. 10, the method for security key update may include but is not limited to the following steps.

In step 1001, a first counter is updated according to a first criterion, the first counter is configured to determine a security key corresponding to a candidate cell or candidate cell group, and the first criterion is addition of a first numerical value to a current value of the first counter.

It should be noted that, for the explanation and illustration of the first criterion, the first counter, the candidate cell, the candidate cell group, and the occurrence of the cell group change or addition, reference may be made to the relevant description in any embodiment of the present disclosure, which will not be repeated here.

For example, the security key corresponding to the candidate cell or candidate cell group refers to a security key of a node where the candidate cell or candidate cell group is located.

For example, updating the first counter is updating the value of the first counter.

In embodiments of the present disclosure, the first numerical value may be specified by a protocol, or may be pre-configured by the network device, and the present disclosure does not impose any limitation thereon. For example, the first numerical value is marked as X.

For example, X may be a maximum number of candidate cells or candidate cell groups that are supported to be configured at the same time.

For example, X may be 1.

In embodiments of the present disclosure, the terminal may update the value of the first counter according to the first criterion. For example, the terminal may add the first numerical value to the current value of the first counter to obtain an updated value of the first counter.

In step 1002, the security key corresponding to the candidate cell or candidate cell group is determined according to the first counter.

In embodiments of the present disclosure, the terminal may determine the security key corresponding to the candidate cell or candidate cell group according to the updated value of the first counter.

As a possible implementation, the network device may also update the first counter according to the first criterion, and the first counter is used to determine the security key corresponding to the candidate cell or candidate cell group; the first criterion is addition of the first numerical value to the current value of the first counter; and the security key corresponding to the candidate cell or candidate cell group is determined according to the first counter.

For example, the value of the first counter updated by the terminal according to the first criterion is the same as that updated by the network device according to the first criterion, and the security key calculated by the terminal according to the updated value of the first counter is also the same as that calculated by the network device according to the updated value of the first counter.

As a possible implementation, the first counter may be a common counter, or may be a counter specific to a candidate cell group or candidate cell.

The common counter is applicable to any candidate cell or any candidate cell group; and the specific counter means that each candidate cell or candidate cell group corresponds to a first counter.

As a possible implementation, when the cell group change or addition occurs, the terminal and the network device updates the value of the first counter (for the first counter that is a common counter).

As a possible implementation, for the case where the first counter is the common counter, when the terminal subsequently activates any candidate cell or candidate cell group, the security key of the candidate cell or candidate cell group is obtained according to the updated value of the first counter (the first counter is used for the activation of the subsequent candidate cell or candidate cell group).

It may be understood that when the first counter is the common counter, all current candidate cells or candidate cell groups of the terminal correspond to the first counter, and when any candidate cell or candidate cell group is activated, the security key generated by this first counter is used.

As a possible implementation, when the cell group change or addition occurs, the terminal and the network device update the value of the first counter (for the first counter that is a counter specific to a candidate cell or candidate cell group) corresponding to the candidate cell or candidate cell group that needs to be activated (i.e., a cell group that corresponds to the operation of the cell group change or addition and needs to be accessed).

With the method for security key update according to embodiments of the present disclosure, the terminal updates the first counter according to the first criterion, the first counter is used to determine the security key corresponding to the candidate cell or candidate cell group, the first criterion is addition of the first numerical value to the current value of the first counter, and the security key corresponding to the candidate cell or candidate cell group is determined according to the first counter. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 11, FIG. 11 is a schematic flowchart of another method for security key update according to embodiments of the present disclosure. The method for security key update may be performed by a terminal as shown in FIG. 4.

The method for security key update may be performed alone, or in combination with any embodiment of the present disclosure or a possible implementation of an embodiment, or in combination with any technical solution in the related art.

As shown in FIG. 11, the method for security key update may include but is not limited to a following step.

In step 1101, in response to occurrence of a cell group change or addition, a first counter is updated according to a first criterion, the first counter is configured to determine a security key corresponding to a candidate cell or cell group that corresponds to the first counter and is to be activated next time.

It should be noted that, for the explanation and illustration of the first criterion, the first counter, the candidate cell, the candidate cell group, and the occurrence of the cell group change or addition, reference may be made to the relevant description in any embodiment of the present disclosure, which will not be repeated here.

For example, the security key corresponding to the candidate cell or candidate cell group refers to a security key of a node where the candidate cell or cell group is located.

For example, updating the first counter is updating the value of the first counter.

In embodiments of the present disclosure, when the cell group change or addition occurs, the terminal can update the value of the first counter according to the first criterion, and the updated value of the first counter is used to determine the security key corresponding to the candidate cell or candidate cell group that corresponds to the first counter and is to be activated next time.

As an example, the terminal may update the first counter corresponding to the candidate cell or candidate cell group that needs to be activated (i.e., a cell group that corresponds to the operation of the cell group change or addition and needs to be accessed), so that when the terminal subsequently activates the above-mentioned candidate cell or candidate cell group, it may determine the security key corresponding to the candidate cell or candidate cell group according to the updated first counter.

In a possible implementation of an embodiment of the present disclosure, the first counter may be a counter specific to the candidate cell or candidate cell group, and there exists a correspondence between candidate cells or candidate cell groups and first counters. For example, each candidate cell or candidate cell group corresponds to a first counter.

As an example, each candidate cell or candidate cell group corresponds to a different first counter. When a candidate cell or candidate cell group is activated, the current value of the first counter corresponding to the activated candidate cell or candidate cell group may be used to generate a security key, and the value of the first counter corresponding to this candidate cell or candidate cell group is updated, and the updated value of the first counter may be used for the next activation of this candidate cell or candidate cell group.

With the method for security key update according to embodiments of the present disclosure, the terminal updates the first counter according to the first criterion in response to the occurrence of the cell group change or addition, and the first counter is used to determine the security key corresponding to the candidate cell or candidate cell group that corresponds to the first counter and is to be activated next time. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 12, FIG. 12 is a schematic flowchart of another method for security key update according to embodiments of the present disclosure. The method for security key update may be performed by a terminal as shown in FIG. 4.

The method for security key update may be performed alone, or in combination with any embodiment of the present disclosure or a possible implementation of an embodiment, or in combination with any technical solution in the related art.

As shown in FIG. 12, the method for security key update may include but is not limited to a following step.

In step 1201, a security key corresponding to a candidate cell or candidate cell group is determined according to a first criterion, the first criterion is addition of a first numerical value to a current value of a first counter corresponding to the candidate cell or candidate cell group, and a value range of a first counter corresponding to each candidate cell or candidate cell group is different from one another.

It should be noted that, for the explanation and illustration of the first counter, the candidate cell, and the candidate cell group, reference may be made to the relevant description in any embodiment of the present disclosure, which will not be repeated here.

For example, the security key corresponding to the candidate cell or candidate cell group refers to a security key of a node where the candidate cell or cell group is located.

For example, updating the first counter is updating the value of the first counter.

In embodiments of the present disclosure, the first numerical value may be specified by a protocol, or may be pre-configured by the network device, and the present disclosure does not impose any limitation thereon.

As an example, X may be a maximum number of candidate cells or candidate cell groups that the network device supports to be configured simultaneously.

As another example, X may be 1.

In embodiments of the present disclosure, the first criterion may include: adding the first numerical value to the current value of the first counter corresponding to the candidate cell or candidate cell group. The value range of the first counter corresponding to each candidate cell or candidate cell group is different from one another. For example, the value range of the first counter corresponding to each candidate cell or candidate cell group does not overlap with one another. For example, the value range of the first counter corresponding to a candidate cell group 1 is [1,3], while the value range of the first counter corresponding to a candidate cell group 2 is [4,6], and so on.

It should be noted that the value ranges of the first counter are used as examples for explanation. In actual applications, the value range of the first counter corresponding to each candidate cell or candidate cell group may be configured according to actual needs, and the present disclosure does not impose any restrictions thereon.

As an example, different candidate cells or candidate cell groups correspond to different value ranges of first counters, and the value ranges of the first counters corresponding to different candidate cells or candidate cell groups do not overlap. When the first counter of an activated cell or activated cell group needs to be updated, the terminal may add X to the value of the first counter of the currently activated cell or activated cell group to obtain the updated value of the first counter.

Optionally, when the value of the first counter exceeds the value range corresponding to the candidate cell or candidate cell group, the initial value and/or value range of the first counter of the candidate cell or candidate cell group may be reconfigured by the network device.

With the method for security key update according to embodiments of the present disclosure, the terminal determines the security key corresponding to the candidate cell or cell group according to the first criterion, the first criterion is addition of the first numerical value to the current value of the first counter corresponding to the candidate cell or candidate cell group, and the value range of the first counter corresponding to each candidate cell or candidate cell group is different from one another. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 13, FIG. 13 is a schematic flowchart of another method for security key update according to embodiments of the present disclosure. The method for security key update may be performed by a terminal as shown in FIG. 4.

The method for security key update may be performed alone, or in combination with any embodiment of the present disclosure or a possible implementation of an embodiment, or in combination with any technical solution in the related art.

As shown in FIG. 13, the method for security key update may include but is not limited to a following step.

In step 1301, a first counter is updated according to a first criterion, the first counter is configured to determine a security key corresponding to a candidate cell or cell group; the first criterion is addition of a second numerical value to a current value of the first counter corresponding to the candidate cell or candidate cell group, an initial value of the first counter corresponding to each candidate cell or candidate cell group is one of consecutive integers of second numerical value determined by the network device, and the initial value of the first counter corresponding to each candidate cell or cell group is different from one another.

It should be noted that, for the explanation and illustration of the first counter, the candidate cell, and the candidate cell group, reference may be made to the relevant description in any embodiment of the present disclosure, which will not be repeated here.

For example, the security key corresponding to the candidate cell or candidate cell group refers to a security key of a node where the candidate cell or cell group is located.

For example, updating the first counter is updating the value of the first counter.

In embodiments of the present disclosure, the second numerical value may be configured by the network device. For example, the second numerical value may be a maximum number of candidate cells or candidate cell groups that the network device supports to be configured simultaneously, or the second numerical value may be the number of candidate cells or candidate cell groups that are currently configured.

As a possible implementation, when the number of candidate cells or candidate cell groups changes, or when a new candidate cell or candidate cell group is added, the second numerical value and/or the initial value of the first counter of each candidate cell or candidate cell group may be reconfigured by the network device.

In embodiments of the present disclosure, the second numerical value is marked as M, the network device may determine M consecutive integers, and determine the initial value of the first counter corresponding to each candidate cell or candidate cell group according to the M consecutive integers, and the initial value of the first counter corresponding to each candidate cell or candidate cell group is different from one another. When the value of the first counter of an activated candidate cell group or candidate cell needs to be updated, the terminal may add M to the current value of the first counter corresponding to the candidate cell or candidate cell group.

For example, assuming that the number of candidate cell groups is M, initial values of the first counters corresponding to individual candidate cell groups are 0, 1, 2, . . . , M−1, respectively, and after first update, values of the first counters corresponding to individual candidate cell groups are M, M+1, M+2, . . . , 2M−1, respectively.

In any embodiment of the present disclosure, the terminal may store the updated value of the first counter and/or store the security key determined according to the updated value of the first counter.

As a possible implementation, the terminal may store the updated value of the first counter in a predefined terminal variable (UE variable).

As an example, the terminal may store the updated value of the first counter in a terminal variable (var variable), for example, the terminal may store the updated value of the first counter in a dedicated Var variable.

As another possible implementation, the terminal may store the updated value of the first counter in a terminal variable (UE variable) for storing mobility configuration information.

As an example, the terminal may store the updated value of the first counter in a terminal variable (var variable), for example, the terminal may store the updated value of the first counter in a var variable for storing the mobility configuration information.

In an example, the terminal variable may be a terminal variable for storing configuration information of the candidate cell or candidate cell group, such as a terminal variable for storing conditional reconfiguration, VarConditionalReconfig.

For example, after updating the value of the first counter, the terminal may update the value of the first counter stored in VarConditionalReconfig.

For another example, after updating the value of the first counter, the terminal may update the value of the first counter in candidate cell or candidate cell group configuration corresponding to each conditional reconfiguration identifier in VarConditionalReconfig.

For another example, after updating the first counter of the activated cell or cell group, the terminal updates the value of the first counter in candidate cell or candidate cell group configuration corresponding to the conditional reconfiguration identifier corresponding to the activated cell or activated cell group in VarConditionalReconfig.

In any embodiment of the present disclosure, when the terminal triggers mobility (such as CPA or CPC) to access a candidate cell or candidate cell group, at least one of the following steps may be performed:
1. using configuration information of the corresponding candidate cell or candidate cell group to access the corresponding candidate cell or candidate cell group;
2. generating a corresponding security key according to the value of the first counter stored in the terminal variable;
3. updating the value of the first counter according to the first criterion;
4. initiating RACH to the candidate target cell to be accessed (e.g., the changed or added target cell); or
5. sending a reconfiguration completion message to the network device.

As an example, the terminal may send a reconfiguration completion message carrying an SN reconfiguration completion message to the network device (such as an MN). After receiving the reconfiguration completion message, the MN may forward the reconfiguration completion message to an SN corresponding to the candidate target cell to be accessed.

With the method for security key update according to embodiments of the present disclosure, the terminal determines the security key corresponding to the candidate cell or cell group according to the first criterion, the first criterion is addition of the second numerical value to the current value of the first counter corresponding to the candidate cell or candidate cell group, the initial value of the first counter corresponding to each candidate cell or candidate cell group is one of consecutive integers of second numerical value determined by the network device, and the initial value of the first counter corresponding to each candidate cell or cell group is different from one another. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 14, FIG. 14 is a schematic flowchart of another method for security key update according to embodiments of the present disclosure. The method for security key update may be performed by a network device as shown in FIG. 4. For example, the network device may be an MN currently serving a terminal.

The method for security key update may be performed alone, or in combination with any embodiment of the present disclosure or a possible implementation of an embodiment, or in combination with any technical solution in the related art.

As shown in FIG. 14, the method for security key update may include but is not limited to a following step.

In step 1401, a security key corresponding to a candidate cell or cell group is determined according to a first criterion.

In embodiments of the present disclosure, the first criterion may be specified by a protocol.

In embodiments of the present disclosure, the candidate cell group may be for example a candidate SCG, and the candidate cell may be for example a candidate PSCell.

For example, the security key corresponding to the candidate cell or candidate cell group refers to a security key of a node where the candidate cell or cell group is located.

In embodiments of the present disclosure, the network device may determine the security key corresponding to the candidate cell or candidate cell group according to the first criterion specified by the protocol.

As an example, the candidate cell group may be an SCG, and the security key of the candidate cell group may be a security key corresponding to a candidate SN or a candidate PSCell corresponding to the candidate SCG. For example, the security key of the candidate cell group may be K_{SN} (a security key of a candidate SN) or S-K_{gNB} (a security key of a 5G node) or S-K_{eNB} (a security key of a 4G node).

For example, the security key updated by the terminal according to the first criterion is the same as the security key updated by the network device according to the first criterion.

With the method for security key update according to embodiments of the present disclosure, the network device determines the security key corresponding to the candidate cell or cell group according to the first criterion. Therefore, the security key corresponding to the candidate cell or candidate cell group may be updated to avoid the repeated use of the security key, that is, to avoid using the repeated security key to encrypt different data packets, so as to improve the security of data transmission.

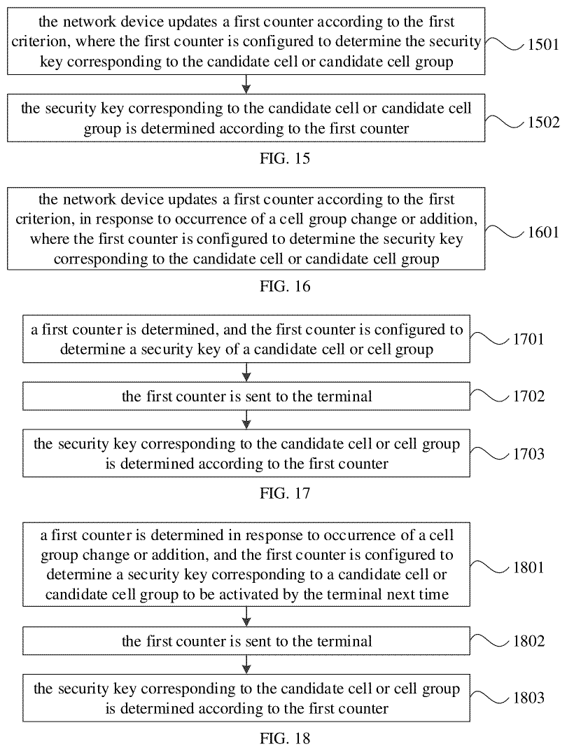

Referring to FIG. 15, FIG. 15 is a schematic flowchart of another method for security key update according to embodiments of the present disclosure. The method for security key update may be performed by a network device as shown in FIG. 4. For example, the network device may be an MN currently serving a terminal.

The method for security key update may be performed alone, or in combination with any embodiment of the present disclosure or a possible implementation of an embodiment, or in combination with any technical solution in the related art.

As shown in FIG. 15, the method for security key update may include but is not limited to the following steps.

In step 1501, a first counter is updated according to a first criterion, and the first counter is configured to determine a security key corresponding to a candidate cell or candidate cell group.

In step 1502, the security key corresponding to the candidate cell or candidate cell group is determined according to the first counter.

It should be noted that the implementation principle of FIG. 15 is similar to that of FIG. 15, and will not be elaborated here.

With the method for security key update according to embodiments of the present disclosure, the network device updates the first counter according to the first criterion, the first counter is used to determine the security key corresponding to the candidate cell or cell group, and the security key corresponding to the candidate cell or candidate cell group is determined according to the first counter. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 16, FIG. 16 is a schematic flowchart of another method for security key update according to embodiments of the present disclosure. The method for security key update may be performed by a network device as shown in FIG. 4. For example, the network device may be an MN currently serving a terminal.

The method for security key update may be performed alone, or in combination with any embodiment of the present disclosure or a possible implementation of an embodiment, or in combination with any technical solution in the related art.

As shown in FIG. 16, the method for security key update may include but is not limited to a following step.

In step 1601, in response to occurrence of a cell group change or addition, a first counter is updated according to a first criterion, and the first counter is configured to determine a security key corresponding to a candidate cell or cell group.

It should be noted that the implementation principle of FIG. 16 is similar to that of FIG. 7, and will not be elaborated here.

In any embodiment of the present disclosure, the first counter is updated synchronously by the terminal and the network device.

In any embodiment of the present disclosure, the first criterion may be to add a first numerical value to a current value of the first counter.

In any embodiment of the present disclosure, the first counter may be configured to determine a security key corresponding to a candidate cell or candidate cell group to be activated by the terminal next time.

In any embodiment of the present disclosure, the first counter is a universal counter, and the universal counter is applicable to any candidate cell or candidate cell group.

In any embodiment of the present disclosure, the first counter is configured to determine a security key corresponding to a candidate cell or candidate cell group that is to be activated by the terminal next time and corresponds to the first counter.

In any embodiment of the present disclosure, the first counter is a counter specific to the candidate cell or candidate cell group, and a correspondence exists between the candidate cell or candidate cell group and the first counter.

In any embodiment of the present disclosure, the first criterion may be to add a first numerical value to the current value of the first counter corresponding to the candidate cell or candidate cell group; and a value range of the first counter corresponding to each candidate cell or candidate cell group is different from one another.

In any embodiment of the present disclosure, the first criterion may be to add a second numerical value to the current value of the first counter corresponding to the candidate cell or candidate cell group; an initial value of the first counter corresponding to each candidate cell or candidate cell group is one of consecutive integers of second numerical value determined by the network device, and the initial value of the first counter corresponding to each candidate cell or cell group is different from one another.

In any embodiment of the present disclosure, the second numerical value is a number of candidate cells or candidate cell groups currently configured by the network device, or the second numerical value is a maximum number of candidate cells or candidate cell groups that the network device supports to be configured simultaneously.

In any embodiment of the present disclosure, an initial value of the first counter is configured by the network device.

In any embodiment of the present disclosure, occurrence of the cell group change or addition includes at least one of the following cases:
1) The network device receives a reconfiguration completion message sent by the terminal.
2) The terminal successfully accesses a changed target cell; or the terminal successfully accesses an added target cell; the terminal successfully accesses a changed target cell group; or the terminal successfully accesses an added target cell group.
3) The network device, as the master node, receives a security key update request message sent by a secondary node.

In any embodiment of the present disclosure, in the case where the network device is the MN, the MN may further perform at least one of the following steps:

1. Sending an updated security key to an SN corresponding to a candidate cell or candidate cell group currently activated.

For example, when the first counter is a counter specific to a candidate cell or candidate cell group, after generating a security key of an SN corresponding to the candidate cell group or candidate cell, the MN may send the security key to the SN corresponding to the candidate cell or candidate cell group currently activated.

The SN corresponding to the candidate cell group may include an SN of a cell group activated and/or an SN of a cell group to be activated.

2. Sending an updated security key to an SN that sends a security key update request message.

For example, when the first counter is a counter specific to the candidate cell or candidate cell group, after receiving the security key update request message sent by the SN, the MN may determine the security key corresponding to the candidate cell or candidate cell group according to the first criterion, and send the security key to the SN that sends the security key update request message.

3. Sending an updated security key to an SN corresponding to each candidate cell or candidate cell group.

For example, when the first counter is a common counter, after generating the security key of the SN corresponding to the candidate cell group or candidate cell, the MN may send the security key to SNs corresponding to all unactivated candidate cells or candidate cell groups.

4. Sending an updated security key to an SN corresponding to each unactivated candidate cell or cell group.

For example, when the first counter is a common counter, after generating the security key of the SN corresponding to the candidate cell group or candidate cell, the MN may send the security key to SNs corresponding to all candidate cells or candidate cell groups (activated and unactivated).

As an example, the MN may send the security key to the SN via an SN modification request message (S-NODE MODIFICATION REQUEST) or an SN addition request message (S-NODE ADDITION REQUEST).

It should be noted that the explanation of the method for security key update performed by the terminal in any of the aforementioned embodiments is also applicable to the method for security key update performed by the network device in these embodiments. The implementation principles are similar and the relevant description will not be repeated here.

With the method for security key update according to embodiments of the present disclosure, the network device updates the first counter according to the first criterion in response to occurrence of the cell group change or addition, and the first counter is used to determine the security key corresponding to the candidate cell or cell group. Therefore, the security key corresponding to the candidate cell or candidate cell group may be updated to avoid the repeated use of the security key, that is, to avoid using the repeated security key to encrypt different data packets, so as to improve the security of data transmission.

In any embodiment of the present disclosure, the terminal and the network device each may update the security key corresponding to the candidate cell group or candidate cell according to the specific criterion.

The candidate cell group may be, for example, a candidate SCG, and the candidate cell may be, for example, a candidate PSCell.

As a first possible implementation, the terminal and the network device each update the security key corresponding to the candidate cell or candidate cell group according to the first criterion.

As an example, the first criterion may be specified by a protocol. The security key updated by the terminal according to the first criterion is the same as that updated by the network device according to the first criterion.

As an example, the candidate cell group is an SCG, and the security key corresponding to the candidate cell group is a security key corresponding to a candidate SN or a candidate PSCell corresponding to the candidate cell group. For example, the security key of the candidate cell group may be K_{SN} (a security key of a candidate SN) or S-K_{gNB} (a security key of a 5G node) or S-K_{eNB} (a security key of a 4G node).

As a second possible implementation, the terminal and the network device each, according to the first criterion, update the value of the first counter (SK-counter) for generating or deriving the security key.

It may be understood that if the initial value of the first counter is the same for the terminal and the network device, and the terminal and the network device each update the value of the first counter (SK-counter) according to the same first criterion, then the value of the first counter (SK-counter) updated by the terminal is also the same as the value of the first counter (SK-counter) updated by the network device. In this way, the terminal and the network device may subsequently make calculation based on the updated value of the first counter (SK-counter) to obtain the same security key, thereby realizing the update of the security key corresponding to the candidate cell group or the candidate cell.

The initial value of the first counter (SK-counter) is configured by the network device to the terminal.

As a third possible implementation, on the basis of the first or second possible implementation, when the cell group change or addition occurs (such as SCG change or SCG addition), the terminal and the network device each update the value of the first counter (SK-counter) corresponding to the candidate cell group or candidate cell according to the first criterion.

For the terminal side, the occurrence of the cell group change or addition may include at least one of:
1. the terminal triggering a cell group change or addition (for example, the terminal meets the trigger condition for CPAC);
2. the terminal sending a reconfiguration completion message;
3. the terminal initiating RACH; or
4. the terminal successfully accessing a changed or added target cell or target cell group.

For example, the value of the first counter (SK-counter) updated by the terminal may be used for the currently activated cell group (for example, the terminal updates the value of the first counter after meeting the trigger condition for CPAC and before sending an RACH and/or reconfiguration completion message), or may be used for the activation of a subsequent candidate cell group.

For the network device side, the occurrence of the cell group change or addition may include one or more of:
1) receiving the reconfiguration completion message sent by the terminal;
2) the terminal successfully accessing a changed or added target cell or cell group; or
3) the network device, as the MN, receiving a security key update request message sent by an SN.

For example, the value of the first counter updated by the network device and the security key calculated according to the updated value of the first counter may be used for activation of a subsequent candidate cell or candidate cell group.

As a fourth possible implementation, the first criterion is addition of the first numerical value X to the current value of the first counter (SK-counter), where X is a value specified by a protocol or a value pre-configured by the network device.

For example, X may be a maximum number of candidate cells or candidate cell groups that are supported to be configured at the same time.

For example, X may be 1.

As a fifth possible implementation, in any possible implementation from the first to fourth possible implementations, the first counter (SK-counter) may be a common counter, or the first counter (SK-counter) may be a counter specific to the candidate cell group or candidate cell.

As a sixth possible implementation, when any situation in the third possible implementation occurs, the terminal and the network device update the value of the first counter (for the first counter that is a common counter).

As a seventh possible implementation, for the sixth possible implementation, when the terminal activates any candidate cell or candidate cell group subsequently, the security key of the candidate cell or candidate cell group is obtained according to the updated value of the first counter (the first counter is used for the activation of a subsequent candidate cell or candidate cell group).

It may be understood that all current candidate cells or candidate cell groups of the terminal correspond to the first counter, and the security key generated by this first counter is used when any candidate cell or candidate cell group is activated.

As an eighth possible implementation, when any of the situations in the third possible implementation occurs in the terminal or the network device, the terminal and the network device update the value of the first counter (for the first counter that is a counter specific to the candidate cell group) corresponding to the candidate cell or candidate cell group that needs to be activated (i.e., a cell group that corresponds to the operation of the cell group change or addition and needs to be accessed).

As a ninth possible implementation, for the eighth possible implementation, when the terminal activates this candidate cell or candidate cell group again subsequently, the security key of this candidate cell or candidate cell group is obtained according to the updated value of the first counter (a specific counter) of this candidate cell or candidate cell group (the first counter is used for subsequent activation of the candidate cell or candidate cell group).

It may be understood that all candidate cell groups or candidate cells of the terminal correspond to different first counters. When a candidate cell or candidate cell group is activated, the current value of the first counter corresponding to this candidate cell or candidate cell group needs to be used to generate a security key, and the value of the first counter (a specific counter) corresponding to this candidate cell or candidate cell group is updated for the next activation of this candidate cell or candidate cell group.

As a tenth possible implementation, for the fourth or eighth possible implementation, the first criterion may include any one of the following.

First, different candidate cell groups or candidate cells correspond to different value ranges of first counters, and the value ranges of the first counters corresponding to different candidate cell groups or candidate cells do not overlap. When the first counter of an activated cell or cell group needs to be updated, the terminal and the network device each add 1 to the current value of the first counter. When the value of the counter exceeds the value range of the first counter corresponding to a respective one of these different candidate cell groups or candidate cells, the network device reconfigures the first counter for the candidate cell group or candidate cell.

Therefore, since the value ranges of the first counters corresponding to different candidate cell groups or candidate cells are different, when accessing different cell groups or cells, security keys generated or used are different.

Second, the network device determines M consecutive integers, and determines the initial value of the first counter corresponding to each candidate cell or candidate cell group according to the M consecutive integers, and the initial value of the first counter corresponding to each candidate cell or candidate cell group is different from one another. When the first counter of an activated cell or cell group needs to be updated, both the terminal and the network device add M to the current value of the first counter. M is the maximum number of candidate cells or candidate cell groups that may be configured simultaneously by the network.

For example, assuming that the number of candidate cell groups is M, initial values of the first counters corresponding to individual candidate cell groups may be 0, 1, 2, . . . , M−1, respectively, and after first update, values of the first counters corresponding to individual candidate cell groups are M, M+1, M+2, . . . , 2M−1, respectively.

For example, M may also be the number of currently configured candidate cell groups or candidate cells. If the number of the candidate cell groups or candidate cells changes, or a new candidate cell group or candidate cell is added, the network device reconfigures the first counters of the candidate cell groups or candidate cells.

As an eleventh possible implementation, for the first counter, the terminal needs to store the updated value of the first counter and/or store the security key determined according to the updated value of the first counter (the first counter is used for subsequent activation of a candidate cell or candidate cell group).

As a twelfth possible implementation, for the eleventh possible implementation, the terminal may store or update the above information in a terminal variable (var variable). The terminal may store the above information in a dedicated Var variable, or store the above information in a var variable for storing mobility configuration information.

For example, the terminal variable may be a terminal variable for storing configuration information of a candidate cell or candidate cell group, such as a terminal variable for storing conditional reconfiguration, VarConditionalReconfig.

For example, after updating the value of the first counter, the terminal may update the value of the first counter stored in VarConditionalReconfig (for the first counter that is a common counter).

For another example, after updating the value of the first counter, the terminal may update the value of the first counter in candidate cell or candidate cell group configuration corresponding to each conditional reconfiguration identifier in VarConditionalReconfig (for the first counter that is a common counter).

For another example, after updating the first counter of an activated cell or cell group, the terminal updates the value of the first counter in candidate cell or candidate cell group configuration corresponding to the conditional reconfiguration identifier corresponding to the activated cell or activated cell group in VarConditionalReconfig (for the first counter that is a counter specific to a candidate cell or candidate cell group).

For example, when storing or updating the value of the first counter or the security key, each first counter value or security key corresponds to a candidate cell or candidate cell group to be activated (or a candidate cell group configuration) (for the first counter that is a counter specific to a candidate cell or candidate cell group).

As a thirteenth possible implementation, based on the eleventh or twelfth possible implementation, when the terminal triggers mobility (such as CPA or CPC) to access a candidate cell group or candidate cell, the terminal may perform one or more of the following steps:
1. using corresponding configuration information of the candidate cell or candidate cell group to access the candidate cell or candidate cell group;
2. generating a corresponding security key according to the value of the corresponding first counter stored in the terminal variable;
3. updating the value of the first counter according to the first criterion;
4. initiating RACH to the candidate target cell to be accessed (e.g., the changed or added target cell or target cell group); or
5. sending a reconfiguration completion message to the network device.

For example, a reconfiguration completion message carrying an SN reconfiguration completion message may be sent to the network device serving as an MN. After receiving the reconfiguration completion message, the MN forwards the reconfiguration completion message to the SN corresponding to the candidate target cell to be accessed (e.g., the changed or added target cell or target cell group).

As a fourteenth possible implementation, based on any possible implementation from the first to thirteenth possible implementations, the network device may be a master node MN currently serving the terminal. When the MN receives the reconfiguration completion message sent by the terminal, or when the MN receives the security key update request message sent by an SN, the MN updates the value of the first counter according to the first criterion, generates a security key of a candidate SN (a candidate SN corresponding to the candidate cell group or candidate cell) according to the updated value of the first counter, and performs at least one of the following steps:

(1) Sending the security key to an SN corresponding to a candidate cell or candidate cell group currently activated (for the first counter that is a counter specific to a candidate cell or candidate cell group).

For example, when the first counter is a counter specific to a candidate cell or candidate cell group, after generating a security key of an SN corresponding to the candidate cell group or candidate cell, the MN may send the security key to the SN corresponding to the candidate cell or candidate cell group currently activated.

The SN corresponding to the candidate cell group may include an SN of a cell group activated and/or an SN of a cell group to be activated.

(2) Sending the security key to an SN that sends a security key update request message (for the first counter that is a counter specific to a candidate cell or candidate cell group).

For example, when the first counter is a counter specific to a candidate cell or candidate cell group, after receiving the security key update request message sent by the SN, the MN may determine the security key corresponding to the candidate cell or candidate cell group according to the first criterion, and send the security key to the SN that sends the security key update request message.

(3) Sending the security key to SNs corresponding to all unactivated candidate cells or candidate cell groups (for the first counter that is a common counter).

For example, when the first counter is a common counter, after generating the security key of the SN corresponding to the candidate cell group or candidate cell, the MN may send the security key to SNs corresponding to all unactivated candidate cells or candidate cell groups.

(4) Sending the security key to SNs corresponding to all candidate cells or candidate cell groups (activated and unactivated) (for the first counter that is a common counter).

For example, when the first counter is a common counter, after generating the security key of the SN corresponding to the candidate cell group or candidate cell, the MN may send the security key to SNs corresponding to all candidate cells or candidate cell groups (activated and unactivated).

As an example, the MN may send the security key to the SN via an SN modification request message (S-NODE MODIFICATION REQUEST)/an SN addition request message (S-NODE ADDITION REQUEST).

Referring to FIG. 17, FIG. 17 is a schematic flowchart of another method for security key update according to embodiments of the present disclosure. The method for security key update may be performed by a network device as shown in FIG. 4. For example, the network device may be an MN currently serving a terminal.

The method for security key update may be performed alone, or in combination with any embodiment of the present disclosure or a possible implementation of an embodiment, or in combination with any technical solution in the related art.

As shown in FIG. 17, the method for security key update may include but is not limited to the following steps.

In step 1701, a first counter is determined, and the first counter is configured to determine a security key of a candidate cell or cell group.

It should be noted that, for the explanation and illustration of the first counter, the candidate cell, and the candidate cell group, reference may be made to the relevant description in any embodiment of the present disclosure, which will not be repeated here.

For example, the security key corresponding to the candidate cell or candidate cell group refers to a security key of a node where the candidate cell or candidate cell group is located.

For example, determining the first counter is determining a value of the first counter.

In embodiments of the present disclosure, the network device may determine the value of the first counter, and the value of the first counter is used to determine the security key of the candidate cell or candidate cell group.

In a possible implementation of an embodiment of the present disclosure, when a cell group change occurs (e.g., an SCG change) or when a cell group addition occurs (e.g., an SCG addition), the network device may update or re-determine the value of the first counter, and the value of the first counter is used to determine the security key of the candidate cell or candidate cell group.

As an example, the network device may add a first numerical value to the current value of the first counter to obtain an updated value of the first counter.

In step 1702, the first counter is sent to the terminal.

In embodiments of the present disclosure, the network device may send the updated value of the first counter to the terminal, so that the terminal may generate the security key corresponding to the candidate cell or candidate cell according to the updated value of the first counter.

As an example, the network device may send the value of the first counter to the terminal via an RRC message.

As an example, sending the first counter to the terminal is sending the value of the first counter to the terminal.

For example, sending the first counter to the terminal may indicate that the terminal may initiate a process corresponding to the cell group change or addition, or the terminal is allowed to continue activating a candidate cell or cell group.

For example, the network device may send the updated value of the first counter to the terminal via an RRC message.

In step 1703, the security key corresponding to the candidate cell or cell group is determined according to the first counter.

In embodiments of the present disclosure, the network device may determine the security key corresponding to the candidate cell or candidate cell group according to the updated value of the first counter.

It should be noted that the present disclosure does not limit the execution sequence of the steps 1602 and 1603. The case where the step 1602 is performed before the step 1603 is used as an example for explanation of the present disclosure. In actual application, the step 1602 may also be performed after the step 1603, or the step 1602 may also be performed in parallel with the step 1603. There is no limitation thereon.

With the method for security key update according to embodiments of the present disclosure, the network device determines the first counter, and the first counter is used to determine the security key corresponding to the candidate cell or candidate cell group; the network device sends the first counter to the terminal; and the security key corresponding to the candidate cell or candidate cell group is determined according to the first counter. Therefore, the security key corresponding to the candidate cell or candidate cell group may be updated to avoid the repeated use of the security key, that is, to avoid using the repeated security key to encrypt different data packets, so as to improve the security of data transmission.

Referring to FIG. 18, FIG. 18 is a schematic flowchart of another method for security key update according to embodiments of the present disclosure. The method for security key update may be performed by a network device as shown in FIG. 4. For example, the network device may be an MN currently serving a terminal.

The method for security key update may be performed alone, or in combination with any embodiment of the present disclosure or a possible implementation of an embodiment, or in combination with any technical solution in the related art.

As shown in FIG. 18, the method for security key update may include but is not limited to the following steps.

In step 1801, in response to occurrence of a cell group change or addition, a first counter is determined, and the first counter is configured to determine a security key corresponding to a candidate cell or candidate cell group to be activated by the terminal next time.

It should be noted that, for the explanation and illustration of the first counter, the candidate cell, and the candidate cell group, reference may be made to the relevant description in any embodiment of the present disclosure, which will not be repeated here.

For example, determining the first counter is determining a value of the first counter.

In embodiments of the present disclosure, when the cell group change or addition occurs, the network device may update or re-determine the value of the first counter, and the updated value of the first counter is used to determine the security key corresponding to the candidate cell or candidate cell group to be activated by the terminal next time.

As an example, when the terminal meet a trigger condition for CPAC, for example when the terminal is about to activate a candidate cell or candidate cell group, the network device may update or re-determine the value of the first counter, so that the security key corresponding to the candidate cell or candidate cell group to be activated next time may be determined according to the updated value of the first counter.

As another example, before or after the activation of a cell group currently activated by the terminal is completed, the network device may update or re-determine the value of the first counter, so that the terminal may determine the security key corresponding to the candidate cell or candidate cell group to be activated next time according to the updated value of the first counter, and wait for the activation of a subsequent candidate cell or candidate cell group.

In any embodiment of the present disclosure, the first counter may be a common or universal counter, and the common or universal counter is applicable to any candidate cell or any candidate cell group.

In any embodiment of the present disclosure, occurrence of the cell group change or addition includes at least one of the following cases:
1) The network device receives a reconfiguration completion message sent by the terminal.
2) The terminal successfully accesses a changed target cell; or the terminal successfully accesses an added target cell; the terminal successfully accesses a changed target cell group; or the terminal successfully accesses an added target cell group.
3) The network device, as the master node, receives a security key update request message sent by a secondary node.

In step 1802, the first counter is sent to the terminal.

In step 1803, the security key corresponding to the candidate cell or cell group is determined according to the first counter.

The steps 1802 to 1803 each may be implemented in any manner as described in various embodiments of the present disclosure, which are not limited in embodiments of the present disclosure and will not be described in detail again.

With the method for security key update according to embodiments of the present disclosure, the network device determines the first counter in response to the occurrence of the cell group change or addition, and the first counter is used to determine the security key corresponding to the candidate cell or candidate cell group; the first counter is sent to the terminal; and the security key corresponding to the candidate cell or candidate cell group is determined according to the first counter. Therefore, the security key corresponding to the candidate cell or the candidate cell group may be updated to avoid the repeated use of the security key, that is, to avoid using the repeated security key to encrypt different data packets, so as to improve the security of data transmission.

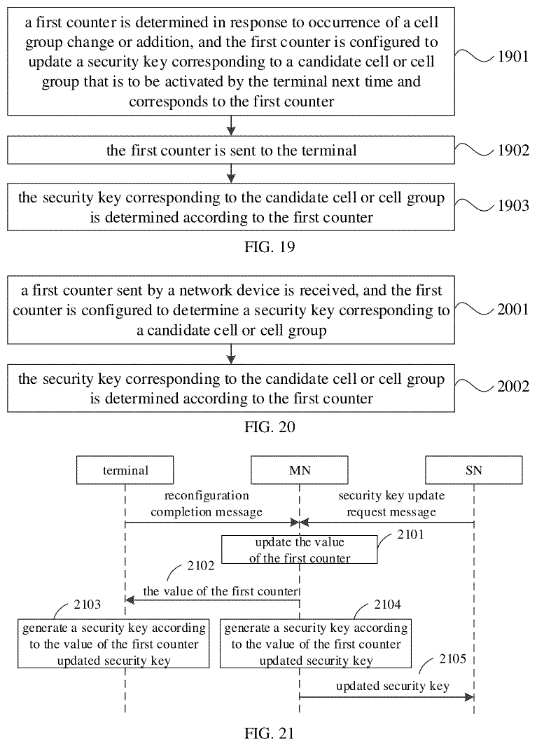

Referring to FIG. 19, FIG. 19 is a schematic flowchart of another method for security key update according to embodiments of the present disclosure. The method for security key update may be performed by a network device as shown in FIG. 4. For example, the network device may be an MN currently serving a terminal.

The method for security key update may be performed alone, or in combination with any embodiment of the present disclosure or a possible implementation of an embodiment, or in combination with any technical solution in the related art.

As shown in FIG. 19, the method for security key update may include but is not limited to the following steps.

In step 1901, in response to occurrence of a cell group change or addition, a first counter is determined, and the first counter is configured to update a security key corresponding to a candidate cell or cell group that is to be activated by the terminal next time and corresponds to the first counter.

It should be noted that, for the explanation and illustration of the first counter, the candidate cell, the candidate cell group, and the occurrence of the cell group change or addition, reference may be made to the relevant description in any embodiment of the present disclosure, which will not be repeated here.

For example, the security key corresponding to the candidate cell or the candidate cell group refers to a security key of a node where the candidate cell or cell group is located.

For example, determining the first counter is determining a value of the first counter.

In embodiments of the present disclosure, when the cell group change or addition occurs, the network device may update or re-determine the value of the first counter, and the updated value of the first counter is used to update the security key corresponding to the candidate cell or candidate cell group that is to be activated by the terminal next time and corresponds to the first counter.

As an example, the network device may update the first counter corresponding to the candidate cell or candidate cell group that needs to be activated (i.e., a cell group that corresponds to the operation of the cell group change or addition and needs to be accessed), so that when the terminal subsequently activates the above-mentioned candidate cell or candidate cell group, it may determine the security key corresponding to the candidate cell or candidate cell group according to the updated value of the first counter.

In a possible implementation of an embodiment of the present disclosure, the first counter may be a counter specific to the candidate cell or candidate cell group, and there exists a correspondence between candidate cells or candidate cell groups and first counters. For example, each candidate cell or candidate cell group corresponds to a first counter.

As an example, each candidate cell or candidate cell group corresponds to a different first counter. When a candidate cell or candidate cell group is activated, the current value of the first counter corresponding to the activated candidate cell or candidate cell group may be used to generate a security key, and the value of the first counter corresponding to this candidate cell or candidate cell group is updated, and the updated value of the first counter may be used for the next activation of this candidate cell or candidate cell group.

In step 1902, the first counter is sent to the terminal.

In step 1903, the security key corresponding to the candidate cell or candidate cell group is determined according to the first counter.

The steps 1902 to 1903 each may be implemented in any manner as described in various embodiments of the present disclosure, which are not limited in embodiments of the present disclosure and will not be described in detail again.

In any embodiment of the present disclosure, in the case where the network device is the MN, the MN may further perform at least one of the following steps:

1. Sending an updated security key to an SN corresponding to a candidate cell or candidate cell group currently activated.

For example, when the first counter is a counter specific to a candidate cell or candidate cell group, after generating a security key of an SN corresponding to the candidate cell group or candidate cell, the MN may send the security key to the SN corresponding to the candidate cell or candidate cell group currently activated.

The SN corresponding to the candidate cell group may include an SN of a cell group activated and/or an SN of a cell group to be activated.

2. Sending an updated security key to an SN that sends a security key update request message.

For example, when the first counter is a counter specific to the candidate cell or candidate cell group, after receiving the security key update request message sent by the SN, the MN may re-determine the security key corresponding to the candidate cell or candidate cell group, and send the re-determined security key to the SN that sends the security key update request message.

3. Sending an updated security key to an SN corresponding to each candidate cell or candidate cell group.

For example, when the first counter is a common counter, after generating the security key of the SN corresponding to the candidate cell group or candidate cell, the MN may send the security key to SNs corresponding to all unactivated candidate cells or candidate cell groups.

4. Sending an updated security key to an SN corresponding to each unactivated candidate cell or cell group.

For example, when the first counter is a common counter, after generating the security key of the SN corresponding to the candidate cell group or candidate cell, the MN may send the security key to SNs corresponding to all candidate cells or candidate cell groups (activated and unactivated).

As an example, the MN may send the security key to the SN via an SN modification request message (S-NODE MODIFICATION REQUEST) or an SN addition request message (S-NODE ADDITION REQUEST).

As an example, the network device may send the updated value of the first counter to the terminal via an RRC message.

With the method for security key update according to embodiments of the present disclosure, the network device determines the first counter in response to the occurrence of the cell group change or addition, and the first counter is used to determine the security key corresponding to the candidate cell or candidate cell group; the first counter is sent to the terminal; and the security key corresponding to the candidate cell or candidate cell group is determined according to the first counter. Therefore, the security key corresponding to the candidate cell or the candidate cell group may be updated to avoid the repeated use of the security key, that is, to avoid using the repeated security key to encrypt different data packets, so as to improve the security of data transmission.

Referring to FIG. 20, FIG. 20 is a schematic flowchart of another method for security key update according to embodiments of the present disclosure. The method for security key update may be performed by a terminal as shown in FIG. 4.

The method for security key update may be performed alone, or in combination with any embodiment of the present disclosure or a possible implementation of an embodiment, or in combination with any technical solution in the related art.

As shown in FIG. 20, the method for security key update may include but is not limited to a following step.

In step 2001, a first counter sent by a network device is received, and the first counter is configured to determine a security key corresponding to a candidate cell or cell group.

It should be noted that, for the explanation and illustration of the first counter, the candidate cell, and the candidate cell group, reference may be made to the relevant description in any embodiment of the present disclosure, which will not be repeated here.

For example, the security key corresponding to the candidate cell or the candidate cell group refers to a security key of a node where the candidate cell or cell group is located.

In embodiments of the present disclosure, the network device may update or re-determine the value of the first counter, for example, the network device may update or re-determine the value of the first counter when a cell group change occurs (e.g., an SCG change) or a cell group addition occurs (e.g., an SCG addition), and the updated value of the first counter is used to determine the security key of the candidate cell or candidate cell group. Furthermore, the network device may send the updated value of the first counter to the terminal, and accordingly, the terminal may receive the updated value of the first counter sent by the network device.

For example, when the cell group change or addition occurs (e.g., the SCG change or the SCG addition), the network device sends the value of the first counter corresponding to the candidate cell or candidate cell group to the terminal.

For example, occurrence of the cell group change or addition may include one or more of:
1. the network device receiving a reconfiguration completion message sent by the terminal;
2. the terminal successfully accessing a changed or added target cell or target cell group; or
3. the network device, as an MN, receiving a security key update request message sent by an SN.

In step 2002, the security key corresponding to the candidate cell or candidate cell group is determined according to the first counter.

In embodiments of the present disclosure, the terminal may determine the security key corresponding to the candidate cell or candidate cell group according to the updated value of the first counter.

For example, both the terminal and the network device may determine the security key corresponding to the candidate cell or candidate cell group according to the updated value of the first counter.

For example, the security key determined by the terminal is the same as that determined by the network device.

For example, the first counter may be a common or universal counter, or may be a counter specific to a candidate cell or candidate cell group. In a possible implementation of an embodiment of the present disclosure, the first counter may be used to determine the security key corresponding to a candidate cell or cell group to be activated by the terminal next time.

In a possible implementation of an embodiment of the present disclosure, the first counter may be a universal counter, and the universal counter is applicable to any candidate cell or candidate cell group.

In a possible implementation of an embodiment of the present disclosure, the first counter may be configured to determine a security key corresponding to a candidate cell or candidate cell group that is to be activated by the terminal next time and corresponds to the first counter.

In a possible implementation of an embodiment of the present disclosure, the first counter may be a counter specific to the candidate cell or candidate cell group, and a correspondence exists between the candidate cell or candidate cell group and the first counter.

In a possible implementation of an embodiment of the present disclosure, in response to receiving the first counter, the terminal initiates a process related to the cell group change or addition.

For example, after the terminal performs the cell group change or addition, the terminal will initiate the process related to the cell group change or addition when receiving the updated value of the first counter sent by the network device.

In a possible implementation of an embodiment of the present disclosure, in response to receiving the first counter, the terminal initiates evaluation of a condition for activating a candidate cell or candidate cell group.

For example, after the terminal performs the cell group change or addition, the terminal will initiate the evaluation of the condition for activating the candidate cell or candidate cell group when receiving the updated value of the first counter sent by the network device.

In a possible implementation of an embodiment of the present disclosure, the updated value of the first counter may be stored in a predefined terminal variable, or the updated value of the first counter may be stored in a terminal variable for storing mobility configuration information.

As an example, the terminal may store or update the above information in a terminal variable (var variable). The terminal may store the above information in a dedicated Var variable, or store the above information in a var variable for storing mobility configuration information.

For example, the terminal variable may be a terminal variable for storing configuration information of a candidate cell or candidate cell group, such as a terminal variable for storing conditional reconfiguration, VarConditionalReconfig.

For example, after receiving the updated value of the first counter sent by the network device, the terminal may update the value of the first counter stored in VarConditionalReconfig (for the first counter that is a common counter).

For another example, after receiving the updated value of the first counter sent by the network device, the terminal may update the value of the first counter in candidate cell or candidate cell group configuration corresponding to each conditional reconfiguration identifier in VarConditionalReconfig (for the first counter that is a common counter).

For another example, after receiving the updated first counter sent by the network device, the terminal may update the first counter in candidate cell or candidate cell group configuration corresponding to the conditional reconfiguration identifier corresponding to an activated cell or activated cell group in VarConditionalReconfig (for the first counter that is a counter specific to a candidate cell or candidate cell group).

For example, when storing or updating the first counter or the security key, each first counter value or security key corresponds to a candidate cell or candidate cell group to be activated (or a candidate cell group configuration) (for the first counter that is a counter specific to a candidate cell or candidate cell group).

With the method for security key update according to embodiments of the present disclosure, the terminal receives the first counter sent by the network device, and the first counter is used to determine the security key corresponding to the candidate cell or candidate cell group; and the security key corresponding to the candidate cell or candidate cell group is determined according to the first counter. Therefore, the security key corresponding to the candidate cell or the candidate cell group may be updated to avoid the repeated use of the security key, that is, to avoid using the repeated security key to encrypt different data packets, so as to improve the security of data transmission.

In any embodiment of the present disclosure, the network device configures the first counter for updating the security key of the candidate cell or candidate cell group to the terminal, and both the terminal and the network device determine the security key corresponding to the candidate cell group or candidate cell according to the value of the first counter sent by the network device.

The candidate cell group may be, for example, a candidate SCG, and the candidate cell may be, for example, a candidate PSCell.

As a first possible implementation, the network device may configure the first counter (SK-counter) for updating the security key of the candidate cell or candidate cell group to the terminal.

As a second possible implementation, based on the first possible implementation, the terminal and the network device determine the security key corresponding to the candidate cell or candidate cell group according to the value of the first counter sent by the network device.

As a third possible implementation, based on the first or second possible implementation, when the cell group change or addition occurs (e.g., the SCG change or SCG addition), the network device sends the value of the first counter corresponding to the candidate cell or candidate cell group to the terminal. The occurrence of the cell group change or addition may include one or more of:
1. receiving the reconfiguration completion message sent by the terminal;
2. the terminal successfully accessing a changed or added target cell or cell group; or
3. the network device, as the MN, receiving a security key update request message sent by an SN.

As a fourth possible implementation, the first counter may be a common counter, or the first counter may be a counter specific to the candidate cell or candidate cell group.

As a fifth possible implementation, when receiving the updated value of the first counter sent by the network device, the terminal needs to store the updated value of the first counter and/or the security key calculated according to the updated value of the first counter.

As a sixth possible implementation, for the fifth possible implementation, the terminal may store or update the above information in a terminal variable (var variable). The terminal may store the above information in a dedicated Var variable, or store the above information in a var variable for storing mobility configuration information.

For example, the terminal variable may be a terminal variable for storing configuration information of a candidate cell or candidate cell group, such as a terminal variable for storing conditional reconfiguration, VarConditionalReconfig.

For example, after receiving the updated value of the first counter sent by the network device, the terminal may update the value of the first counter stored in VarConditionalReconfig (for the first counter that is a common counter).

For another example, after receiving the updated value of the first counter sent by the network device, the terminal may update the value of the first counter in candidate cell or candidate cell group configuration corresponding to each conditional reconfiguration identifier in VarConditionalReconfig (for the first counter that is a common counter).

For another example, after receiving the updated first counter sent by the network device, the terminal may update the first counter in candidate cell or candidate cell group configuration corresponding to the conditional reconfiguration identifier corresponding to an activated cell or activated cell group in VarConditionalReconfig (for the first counter that is a counter specific to a candidate cell or candidate cell group).

For example, when storing or updating the first counter or the security key, each first counter value or security key corresponds to a candidate cell or candidate cell group to be activated (or a candidate cell group configuration) (for the first counter that is a counter specific to a candidate cell or candidate cell group).

As a seventh possible implementation, based on the fifth or sixth possible implementation, when the terminal triggers mobility (such as CPA or CPC) to access a candidate cell group or candidate cell, the terminal may perform one or more of the following steps:
1. using corresponding configuration information of the candidate cell or candidate cell group to access the candidate cell or candidate cell group;
2. generating a corresponding security key according to the value of the corresponding first counter stored in the terminal variable;
3. initiating RACH to the candidate target cell to be accessed (e.g., the changed or added target cell or target cell group); or
4. sending a reconfiguration completion message to the network device.

For example, a reconfiguration completion message carrying an SN reconfiguration completion message may be sent to the network device serving as an MN. After receiving the reconfiguration completion message, the MN forwards the reconfiguration completion message to the SN corresponding to the candidate target cell to be accessed (e.g., the changed or added target cell or target cell group).

As an eighth possible implementation, based on the first possible implementation, after the terminal device performs the cell group change or addition, the terminal will perform the subsequent cell group change or addition process when the terminal receives the value of the first counter configured by the network device.

As a ninth possible implementation, based on any possible implementation from the first to eighth possible implementations, the network device may be a master node MN currently serving the terminal. When the MN receives the reconfiguration completion message sent by the terminal, or when the MN receives the security key update request message sent by an SN, the MN generates a new value of the first counter, generates a security key of a candidate SN (a candidate SN corresponding to the candidate cell group or candidate cell) according to the updated value of the first counter, and performs at least one of the following steps:

(1) sending the new value of the first counter to the terminal; or

(2) sending the security key to an SN corresponding to a candidate cell or candidate cell group currently activated (for the first counter that is a counter specific to a candidate cell or candidate cell group).

For example, when the first counter is a counter specific to a candidate cell or candidate cell group, after generating a security key of an SN corresponding to the candidate cell group or candidate cell, the MN may send the security key to the SN corresponding to the candidate cell or candidate cell group currently activated.

The SN corresponding to the candidate cell group may include an SN of a cell group activated and/or an SN of a cell group to be activated.

(3) Sending the security key to an SN that sends a security key update request message (for the first counter that is a counter specific to a candidate cell or candidate cell group).

For example, when the first counter is a counter specific to a candidate cell or candidate cell group, after receiving the security key update request message sent by the SN, the MN may re-determine the security key corresponding to the candidate cell or candidate cell group, and send the re-determined security key to the SN that sends the security key update request message.

(4) Sending the security key to SNs corresponding to all unactivated candidate cells or candidate cell groups (for the first counter that is a common counter).

For example, when the first counter is a common counter, after generating the security key of the SN corresponding to the candidate cell group or candidate cell, the MN may send the security key to SNs corresponding to all unactivated candidate cells or candidate cell groups.

(5) Sending the security key to SNs corresponding to all candidate cells or candidate cell groups (activated and unactivated) (for the first counter that is a common counter).

For example, when the first counter is a common counter, after generating the security key of the SN corresponding to the candidate cell group or candidate cell, the MN may send the security key to SNs corresponding to all candidate cells or candidate cell groups (activated and unactivated).

As an example, the MN may send the security key to the SN via an SN modification request message (S-NODE MODIFICATION REQUEST)/an SN addition request message (S-NODE ADDITION REQUEST).

As an example, the MN may send the new value of the first counter to the terminal via an RRC message.

In any embodiment of the present disclosure, the interaction process among the terminal, the MN and the SN (such as the SN of the activated cell group, the SN of the cell group to be activated) may be as shown in FIG. 21.

In step 2101, when the MN receives a reconfiguration completion message sent by the terminal, and/or when the MN receives a security key update request message sent by the SN, and/or when the terminal successfully accesses a changed or added target cell or cell group, MN may update the value of the first counter.

In step 2102, the updated value of the first counter is sent to the terminal.

In step 2103, the terminal generates a security key of the candidate cell or candidate cell group according to the updated value of the first counter.

In step 2104, the MN generates a security key of the candidate cell or candidate cell group according to the updated value of the first counter.

In step 2105, the MN sends the updated security key to the SN that sends the security key update request message.

Furthermore, the MN may also send the updated security key to an SN corresponding to a candidate cell or candidate cell group currently activated, and/or send the updated security key to an SN corresponding to each candidate cell or candidate cell group.

It should be noted that the present disclosure does not limit the execution sequence of the steps 2102 to 2103 and the steps 2104 to 2105. The case where the steps 2102 to 2103 are performed before the steps 2104 to 2105 is used as an example for explanation of the present disclosure. In actual application, the steps 2102 to 2103 may also be performed after the steps 2104 to 2105, or the steps 2102 to 2103 may also be performed in parallel with the steps 2104 to 2105, and so on. There is no limitation thereon. The present disclosure does not impose any limitation thereon.

In the above embodiments provided in the present disclosure, the methods according to embodiments of the present disclosure are introduced from perspectives of the network device and the terminal respectively. In order to implement the various functions in the methods according to the above embodiments of the present disclosure, the network device and the terminal each may include a hardware structure and/or a software module, and implement the above various functions in a form of the hardware structure, the software module, or the hardware structure in combination with the software module. A certain function among the above various functions may be implemented in the manner of the hardware structure, the software module, or the hardware structure in combination with the software module.

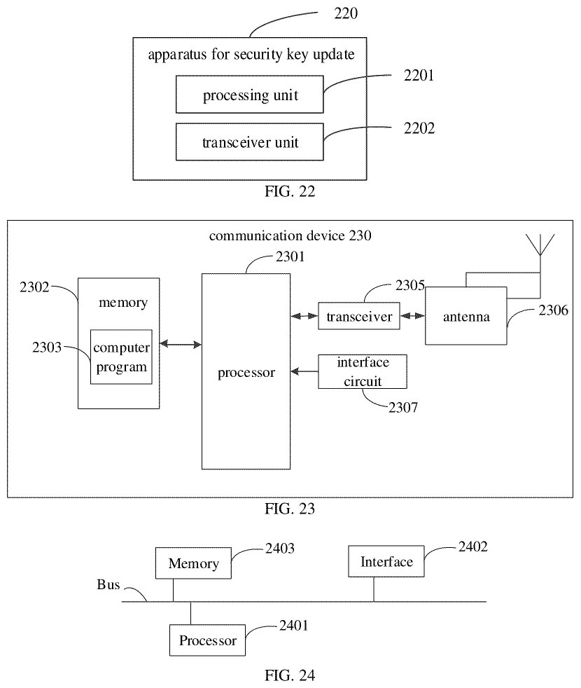

Referring to FIG. 22, FIG. 22 is a schematic block diagram of an apparatus 220 for security key update according to embodiments of the present disclosure. The apparatus 220 for security key update shown in FIG. 22 may include a processing unit 2201 and a transceiver unit 2202. The transceiver unit 2202 may include a sending unit and/or a receiving unit, the sending unit is configured to implement a sending function, the receiving unit is configured to implement a receiving function, and the transceiver unit may implement the sending function and/or the receiving function.

The apparatus 220 for security key update may be a communication node (such as a terminal or a network device), an apparatus in the communication node, or an apparatus that may be used in combination with the communication node.

In the case where the apparatus 220 for security key update is a terminal, the processing unit 2201 is configured to determine a security key corresponding to a candidate cell or cell group according to a first criterion.

In some embodiments, the processing unit 2201 is specifically configured to: update a first counter according to the first criterion, where the first counter is configured to determine the security key corresponding to the candidate cell or cell group; and determine the security key corresponding to the candidate cell or cell group according to the first counter.

In some embodiments, the processing unit 2201 is further configured to: in response to occurrence of a cell group change or addition, update a first counter according to the first criterion, and the first counter is configured to determine the security key corresponding to the candidate cell or cell group.

In some embodiments, the first counter is updated synchronously by the terminal and a network device.

In some embodiments, the first criterion is addition of a first numerical value to a current value of the first counter.

In some embodiments, the first counter is configured to determine a security key corresponding to a candidate cell or cell group to be activated by the terminal next time.

In some embodiments, the first counter is a universal counter, and the universal counter is applicable to any candidate cell or cell group.

In some embodiments, the first counter is configured to determine a security key corresponding to a candidate cell or cell group that is to be activated by the terminal next time and corresponds to the first counter.

In some embodiments, the first counter is a counter specific to the candidate cell or cell group, and a correspondence exists between the candidate cell or cell group and the first counter.

In some embodiments, the first criterion is addition of the first numerical value to the current value of the first counter corresponding to the candidate cell or cell group; and a value range of the first counter corresponding to each candidate cell or cell group is different from one another.

In some embodiments, the first criterion is addition of a second numerical value to the current value of the first counter corresponding to the candidate cell or cell group; an initial value of the first counter corresponding to each candidate cell or cell group is one of consecutive integers of second numerical value determined by the network device, and the initial value of the first counter corresponding to each candidate cell or cell group is different from one another.

In some embodiments, the second numerical value is a number of candidate cells or cell groups currently configured by the network device, or the second numerical value is a maximum number of candidate cells or cell groups that the network device supports to be configured simultaneously.

In some embodiments, an initial value of the first counter is configured by the network device.

In some embodiments, occurrence of the cell group change or addition includes at least one of: the terminal triggering a cell group change or addition; the terminal sending a reconfiguration completion message to the network device; the terminal initiating a random access; or the terminal successfully accessing a target cell or cell group changed or added.

In some embodiments, the first counter is stored in a predefined terminal variable, or the first counter is stored in a terminal variable for storing mobility configuration information.

In the case where the apparatus 220 for security key update is a network device, the processing unit 2201 is configured to determine a security key corresponding to a candidate cell or cell group according to a first criterion.

In some embodiments, the processing unit 2201 is specifically configured to: update a first counter according to the first criterion, where the first counter is configured to determine the security key corresponding to the candidate cell or cell group; and determine the security key corresponding to the candidate cell or cell group according to the first counter.

In some embodiments, the processing unit 2201 is further configured to: in response to occurrence of a cell group change or addition, update a first counter according to the first criterion, and the first counter is configured to determine the security key corresponding to the candidate cell or cell group.

In some embodiments, the first counter is updated synchronously by a terminal and the network device.

In some embodiments, the first criterion is addition of a first numerical value to a current value of the first counter.

In some embodiments, the first counter is configured to determine a security key corresponding to a candidate cell or cell group to be activated by the terminal next time.

In some embodiments, the first counter is a universal counter, and the universal counter is applicable to any candidate cell or cell group.

In some embodiments, the first counter is configured to determine a security key corresponding to a candidate cell or cell group that is to be activated by the terminal next time and corresponds to the first counter.

In some embodiments, the first counter is a counter specific to the candidate cell or cell group, and a correspondence exists between the candidate cell or cell group and the first counter.

In some embodiments, the first criterion is addition of the first numerical value to the current value of the first counter corresponding to the candidate cell or cell group; and a value range of the first counter corresponding to each candidate cell or cell group is different from one another.

In some embodiments, the first criterion is addition of a second numerical value to the current value of the first counter corresponding to the candidate cell or cell group; an initial value of the first counter corresponding to each candidate cell or cell group is one of consecutive integers of second numerical value determined by the network device, and the initial value of the first counter corresponding to each candidate cell or cell group is different from one another.

In some embodiments, the second numerical value is a number of candidate cells or cell groups currently configured by the network device, or the second numerical value is a maximum number of candidate cells or cell groups that the network device supports to be configured simultaneously.

In some embodiments, an initial value of the first counter is configured by the network device.

In some embodiments, occurrence of the cell group change or addition includes at least one of: the network device receiving a reconfiguration completion message sent by a terminal; a terminal successfully accessing a target cell or cell group changed or added; or the network device, as a master node, receiving a security key update request message sent by a secondary node.

In some embodiments, in response to the network device being a master node, the transceiver unit 2202 is further configured to perform at least one of: sending an updated security key to a secondary node corresponding to a candidate cell or cell group currently activated; sending an updated security key to a secondary node that sends a security key update request message; sending an updated security key to a secondary node corresponding to each candidate cell or cell group; or sending an updated security key to a secondary node corresponding to each unactivated candidate cell or cell group.

In the case where the apparatus 220 for security key update is a network device, the processing unit 2201 is configured to determine a first counter, and the first counter is configured to determine a security key of a candidate cell or cell group; the transceiver unit 2202 is configured to send the first counter to a terminal; and the processing unit 2201 is further configured to determine a security key corresponding to the candidate cell or cell group according to the first counter.

In some embodiments, the processing unit 2201 is specifically configured to: determine the first counter in response to occurrence of a cell group change or addition, and the first counter is configured to determine the security key of the candidate cell or cell group.

In some embodiments, the first counter is configured to determine a security key corresponding to a candidate cell or cell group to be activated by the terminal next time.

In some embodiments, the first counter is a universal counter, and the universal counter is applicable to any candidate cell or cell group.

In some embodiments, the first counter is configured to update a security key corresponding to a candidate cell or cell group that is to be activated by the terminal next time and corresponds to the first counter.

In some embodiments, the first counter is a counter specific to the candidate cell or cell group, and a correspondence exists between the candidate cell or cell group and the first counter.

In some embodiments, occurrence of the cell group change or addition includes at least one of: the network device receiving a reconfiguration completion message sent by a terminal; a terminal successfully accessing a target cell or cell group changed or added; or the network device, as a master node, receiving a security key update request message sent by a secondary node.

In some embodiments, in response to the network device being a master node, the transceiver unit 2202 is further configured to perform at least one of: sending an updated security key to a secondary node corresponding to a candidate cell or cell group currently activated; sending an updated security key to a secondary node that sends a security key update request message; sending an updated security key to a secondary node corresponding to each candidate cell or cell group; or sending an updated security key to a secondary node corresponding to each unactivated candidate cell or cell group.

In the case where the apparatus 220 for security key update is a terminal, the transceiver unit 2202 is further configured to receive a first counter sent by a network device, and the first counter is configured to determine a security key corresponding to a candidate cell or cell group. The processing unit 2201 is further configured to determine the security key corresponding to the candidate cell or cell group according to the first counter.

In some embodiments, the first counter is configured to determine a security key corresponding to a candidate cell or cell group to be activated by the terminal next time.

In some embodiments, the first counter is a universal counter, and the universal counter is applicable to any candidate cell or cell group.

In some embodiments, the first counter is configured to determine a security key corresponding to a candidate cell or cell group that is to be activated by the terminal next time and corresponds to the first counter.

In some embodiments, the first counter is a counter specific to the candidate cell or cell group, and a correspondence exists between the candidate cell or cell group and the first counter.

In some embodiments, the processing unit 2201 is further configured to: initiate, by the terminal, a process related to a cell group change or addition, in response to receiving the first counter.

In some embodiments, the processing unit 2201 is further configured to: initiate, by the terminal, evaluation of a condition for activating a candidate cell or cell group, in response to receiving the first counter.

In some embodiments, the first counter is stored in a predefined terminal variable, or the first counter is stored in a terminal variable for storing mobility configuration information.

It should be noted that the explanation and illustration of the method performed by the terminal as described in any of embodiments of FIG. 5 to FIG. 13, or the explanation and illustration of the method performed by the network device as described in any of embodiments of FIG. 14 to FIG. 16, or the explanation and illustration of the method performed by the network device as described in any of embodiments of FIG. 17 to FIG. 19, or the explanation and illustration of the method performed by the terminal as described in the embodiment of FIG. 20 are also applicable to the apparatus 220 for security key update as described in these embodiments, the implementation principles are similar, and the relevant description will not be repeated here.

Referring to FIG. 23, FIG. 23 is a schematic block diagram of a communication device according to embodiments of the present disclosure. The communication device 230 may be a communication node, or may also be a chip, a chip system, or a processor that supports the communication node to implement the above method. The device may be used to implement the methods as described in the above method examples, and for details, reference may be made to the descriptions on the above method examples.

The communication device 230 may include one or more processors 2301. The processor 2301 may be a general-purpose processor or a special-purpose processor. For example, it may be a baseband processor or a central processing unit. The baseband processor may be configured to process a communication protocol and communication data, and the central processing unit may be configured to control the communication device (such as a base station, a baseband chip, a terminal, a terminal chip, a DU or a CU, etc.), execute computer programs, and process data of computer programs.

Optionally, the communication device 230 may further include one or more memories 2302 that may have stored therein a computer program 2303. The processor 2301 executes the computer program 2303 to cause the communication device 230 to implement the methods as described in the above method examples. The computer program 2303 may be solidified in the processor 2301, and in this case, the processor 2301 may be implemented by hardware.

Optionally, the memory 2302 may have stored therein data. The communication device 230 and the memory 2302 may be set separately or integrated together.

Optionally, the communication device 230 may further include a transceiver 2305 and an antenna 2306. The transceiver 2305 may be called a transceiver unit, a transceiver machine, a transceiver circuit or the like, for implementing a transceiver function. The transceiver 2305 may include a receiver and a transmitter. The receiver may be called a receiving machine, a receiving circuit or the like, for implementing a receiving function. The transmitter may be called a sending machine, a sending circuit or the like for implementing a sending function.

Optionally, the communication device 230 may further include one or more interface circuits 2307. The interface circuit 2307 is configured to receive a code instruction and transmit the code instruction to the processor 2301. The processor 2301 runs the code instruction to enable the communication device 230 to execute the methods as described in the foregoing method examples.

In the case where the communication device 230 is a terminal, the processor 2301 is configured to perform any of the method embodiments as described in FIG. 5 to FIG. 13 of the present disclosure, or perform the method embodiment as described in FIG. 20.

In the case where the communication device 230 is a network device, the processor 2301 is configured to perform any of the method embodiments as described in FIG. 14 to FIG. 16 of the present disclosure, or perform any of the method embodiments as described in FIG. 17 to FIG. 19 of the present disclosure.

It should be noted that the explanation and illustration made on the method for security key update in any embodiment as described with reference to FIG. 5 to FIG. 20 are also applicable to the communication device 230 as described in these embodiments, the implementation principles are similar, and the relevant description will not be repeated here.

In an embodiment, the processor 2301 may include the transceiver configured to implement receiving and sending functions. For example, the transceiver may be a transceiver circuit, an interface, or an interface circuit. The transceiver circuit, the interface or the interface circuit configured to implement the receiving and sending functions may be separated or may be integrated together. The above transceiver circuit, interface or interface circuit may be configured to read and write codes/data, or the above transceiver circuit, interface or interface circuit may be configured to transmit or transfer signals.

In an embodiment, the communication device 230 may include a circuit, and the circuit may implement the sending, receiving or communicating function in the foregoing method examples. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured using various IC process technologies, such as a complementary metal oxide semiconductor (CMOS), an nMetal-oxide-semiconductor (NMOS), a P-type metal oxide semiconductor (also called positive channel metal oxide semiconductor, PMOS), a bipolar junction transistor (BJT), a bipolar CMOS (BiCMOS), silicon germanium (SiGe), gallium arsenide (GaAs), etc.

The communication device described in the above embodiments may be a first communication node or a second communication node, but the scope of the communication device described in the present disclosure is not limited thereto, and a structure of the communication device is not limited by FIG. 23. The communication device may be a stand-alone device or may be a part of a larger device. For example, the communication device may be:
(1) a stand-alone integrated circuit (IC), or a chip, or a chip system or subsystem;
(2) a set of one or more ICs, optionally, the set of ICs may also include a storage component for storing data and computer programs;
(3) an ASIC, such as a modem;
(4) a module that may be embedded in other devices;
(5) a receiver, a terminal, an intelligent terminal, a cellular phone, a wireless device, a handheld machine, a mobile unit, a vehicle device, a network device, a cloud device, an artificial intelligence device, etc. ;
(6) others.

For the case where the communication device may be a chip or a chip system, reference may be made to a schematic structural diagram of the chip shown in FIG. 24. The chip shown in FIG. 24 includes a processor 2401 and an interface 2402. In the chip, one or more processors 2401 may be provided, and a plurality of interfaces 2402 may be provided.

For the case where the chip is used to implement functions of the terminal in embodiments of the present disclosure, the interface 2402 is configured to receive a code instruction and transmit the code instruction to the processor; and the processor 2401 is configured to run the code instruction to perform the method in any embodiment as described with reference to FIG. 5 to FIG. 13 or FIG. 20.

For the case where the chip is used to implement functions of the network device in embodiments of the present disclosure, the interface 2402 is configured to receive a code instruction and transmit the code instruction to the processor; and the processor 2401 is configured to run the code instruction to perform the method in any embodiment as described with reference to FIG. 14 to FIG. 19.

Optionally, the chip further includes a memory 2403 for storing necessary computer programs and data.

It should be noted that the explanation and illustration made on the method for security key update in any embodiment as described with reference to FIG. 5 to FIG. 20 are also applicable to the chip as described in these embodiments, the implementation principles are similar, and the relevant description will not be repeated here.

Those skilled in the art may also understand that various illustrative logical blocks and steps listed in examples of the present disclosure may be implemented by electronic hardware, computer software, or a combination thereof. Whether such functions are implemented by hardware or software depends on specific applications and design requirements of an overall system. For each specific application, those skilled in the art may use various methods to implement the described functions, but such implementation should not be understood as beyond the protection scope of examples of the present disclosure.

Embodiments of the present disclosure also provide a communication system. The system includes the apparatus for security key update as the terminal or the network device in above embodiments as described with reference to FIG. 23, or the system includes the communication device as the terminal or the network device in above embodiments as described with reference to FIG. 24.

The present disclosure also provides a readable storage medium having stored therein an instruction that, when executed by a computer, cause the function of any of the above method embodiments to be implemented.

The present disclosure also provides a computer program product that, when executed by a computer, cause the function of any of the above method embodiments to be implemented.

The above embodiments may be implemented in whole or in part by software, hardware, firmware or any combination thereof. When implemented using the software, the above embodiments may be implemented in whole or in part in a form of the computer program product. The computer program product includes one or more computer programs. When the computer program is loaded and executed on the computer, all or part of the processes or functions according to embodiments of the present disclosure will be generated. The computer may be a general purpose computer, a special purpose computer, a computer network, or other programmable devices. The computer program may be stored in a computer-readable storage medium or transmitted from one computer-readable storage medium to another computer-readable storage medium. For example, the computer program may be transmitted from one website site, computer, server or data center to another website site, computer, server or data center in a wired manner (such as via a coaxial cable, an optical fiber, a digital subscriber line (DSL)) or a wireless manner (such as via infrared, wireless, or microwave, etc.). The computer-readable storage medium may be any available medium that can be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), or a semiconductor medium (for example, a solid state disk (SSD)) etc.

Those of ordinary skill in the art can understand that the first, second, and other numeral numbers involved in the present disclosure are only for convenience of description, and are not intended to limit the scope of embodiments of the present disclosure, nor are they intended to represent a sequential order.

The term “at least one” used in the present disclosure may also be described as one or more, and the term “a plurality of/multiple” may cover two, three, four or more, which are not limited in the present disclosure. In embodiments of the present disclosure, for a certain kind of technical features, the technical features in this kind of technical features are distinguished by terms like “first”, “second”, “third”, “A”, “B”, “C” and “D”, etc., and these technical features described with the “first”, “second”, “third”, “A”, “B”, “C” and “D” have no order of priority and have no order of size.

It can be understood that the phrase “a plurality of” in the present disclosure refers to two or more, and other quantifiers are similar thereto. The term “and/or” describes an association relationship of associated objects, indicating that three relationships may exist, for example, the expression “A and/or B” may include the following three cases: A alone, B alone, and both A and B. The character “” generally indicates an “or” relationship of the associated objects. The singular forms “a/an”, “said” and “the” are intended to include plural forms, unless clearly indicated in the context otherwise.

The term “if”′ as used herein may be construed to mean “when” or “upon” or “in response to determining”.

The correspondence shown in each table in the present disclosure may be configured or predefined. The values of various information in each table are just examples, and may be configured as other values, which are not limited in the present disclosure. When configuring a correspondence between the information and various parameters, it is not necessary to configure all the correspondences shown in the tables. For example, the correspondences shown in some rows of a table in the present disclosure may not be configured. For another example, appropriate deformations or adjustments (such as splitting, merging, and so on) can be made based on the above table. The names of parameters shown in the titles of the above tables may also adopt other names understandable by the communication device, and the values or representations of the parameters may also be other values or representations understandable by the communication device. When the above tables are implemented, other data structures may also be used, for example, arrays, queues, containers, stacks, linear tables, pointers, linked lists, trees, graphs, structural body, classes, heaps, or hash tables may be used.

The term “predefinition” in the present disclosure may be understood as definition, definition in advance, storage, pre-storage, pre-negotiation, pre-configuration, curing, or pre-firing.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, device and unit may refer to the corresponding process in the foregoing method embodiments, which will not be repeated here.

The above only describes some specific embodiments of the present disclosure, but the protection scope of the present disclosure is not limited thereto. Any changes or substitutions that are conceivable to those skilled in the art within the technical scope of the present disclosure should fall within the protection scope of the present disclosure. Therefore, the protection scope of the present disclosure should be determined by the protection scope of the claims.

1. A method for security key update, performed by a terminal or a network device, comprising:
determining a security key corresponding to a candidate cell or cell group according to a first criterion.

2. The method according to claim 1, wherein determining the security key corresponding to the candidate cell or cell group according to the first criterion comprises:
updating a first counter according to the first criterion, wherein the first counter is configured to determine the security key corresponding to the candidate cell or cell group; and
determining the security key corresponding to the candidate cell or cell group according to the first counter.

3. The method according to claim 1, further comprising:
in response to occurrence of a cell group change or addition, updating a first counter according to the first criterion, wherein the first counter is configured to determine the security key corresponding to the candidate cell or cell group.

4. (canceled)

5. The method according to claim 3, wherein the first criterion is addition of a first numerical value to a current value of the first counter; or
the first counter is updated synchronously by the terminal and a network device.

6. The method according to claim 5, wherein the first counter is configured to determine a security key corresponding to a candidate cell or cell group to be activated by the terminal next time.

7. The method according to claim 6, wherein the first counter is a universal counter, and the universal counter is applicable to any candidate cell or cell group.

8. The method according to claim 5, wherein the first counter is configured to determine a security key corresponding to a candidate cell or cell group that is to be activated by the terminal next time and corresponds to the first counter.

9. The method according to claim 8, wherein the first counter is a counter specific to the candidate cell or cell group, and a correspondence exists between the candidate cell or cell group and the first counter.

10. The method according to claim 8, wherein the first criterion is addition of the first numerical value to the current value of the first counter corresponding to the candidate cell or cell group; wherein a value range of the first counter corresponding to each candidate cell or cell group is different from one another; or
the first criterion is addition of a second numerical value to the current value of the first counter corresponding to the candidate cell or cell group; wherein an initial value of the first counter corresponding to each candidate cell or cell group is one of consecutive integers of second numerical value determined by a network device, and the initial value of the first counter corresponding to each candidate cell or cell group is different from one another.

11. (canceled)

12. The method according to claim 10, wherein the second numerical value is a number of candidate cells or cell groups currently configured by the network device, or
the second numerical value is a maximum number of candidate cells or cell groups that the network device supports to be configured simultaneously;
wherein the initial value of the first counter is configured by the network device.

13. (canceled)

14. The method according to claim 3, wherein for the terminal, occurrence of the cell group change or addition comprises at least one of:
the terminal triggering a cell group change or addition;
the terminal sending a reconfiguration completion message to a network device;
the terminal initiating a random access; or
the terminal successfully accessing a target cell or cell group changed or added.

15.-28. (canceled)

29. The method according to claim 3, wherein for the network device, occurrence of the cell group change or addition comprises at least one of:
the network device receiving a reconfiguration completion message sent by a terminal;
a terminal successfully accessing a target cell or cell group changed or added; or
the network device, as a master node, receiving a security key update request message sent by a secondary node.

30. The method according to claim 2, wherein the method is performed by the network device, and in response to the network device being a master node, the method further comprises at least one of:
sending an updated security key to a secondary node corresponding to a candidate cell or cell group currently activated;
sending an updated security key to a secondary node that sends a security key update request message;
sending an updated security key to a secondary node corresponding to each candidate cell or cell group; or
sending an updated security key to a secondary node corresponding to each unactivated candidate cell or cell group.

31. A method for security key update, performed by a network device, comprising:
determining a first counter, wherein the first counter is configured to determine a security key of a candidate cell or cell group;
sending the first counter to a terminal; and
determining a security key corresponding to the candidate cell or cell group according to the first counter.

32. The method according to claim 31, wherein determining the first counter comprises:
in response to occurrence of a cell group change or addition, determining the first counter, wherein the first counter is configured to determine the security key of the candidate cell or cell group.

33.-38. (canceled)

39. A method for security key update, performed by a terminal, comprising:
receiving a first counter sent by a network device, wherein the first counter is configured to determine a security key corresponding to a candidate cell or cell group; and
determining the security key corresponding to the candidate cell or cell group according to the first counter.

40.-43. (canceled)

44. The method according to claim 39, further comprising at least one of:
in response to receiving the first counter, initiating, by the terminal, a process related to a cell group change or addition; or
in response to receiving the first counter, initiating, by the terminal, evaluation of a condition for activating a candidate cell or cell group.

45.-50. (canceled)

51. A communication device, comprising:
a processor; and
a memory, having stored therein computer programs,
wherein the processor is configured to perform the method according to claim 1.

52. (canceled)

53. (canceled)

54. A communication device, comprising:
a processor; and
a memory, having stored therein computer programs,
wherein the processor is configured to perform the method according to claim 31.

55. A communication device, comprising:
a processor; and
a memory, having stored therein computer programs,
wherein the processor is configured to perform the method according to claim 39.
